(19) United States
(12) Patent Application Publication
(10) Pub. No.: US 2025/0249415 A1
(43) Pub. Date: Aug. 7, 2025

(54) HOUSING WITH MIXER APPARATUS FOR FLUID MIXING

(71) Applicant: HED SYSTEMS, LLC, Charlotte, NC (US)

(72) Inventors: Bruce E. Nadeau, JR., Charlotte, NC (US); Joseph C. Lull, South Haven, MI (US)

(73) Assignee: HED SYSTEMS, LLC, Charlotte, NC (US)

(21) Appl. No.: 19/037,445

(22) Filed: Jan. 27, 2025

Related U.S. Application Data
(63) Continuation-in-part of application No. 18/679,139, filed on May 30, 2024.
(60) Provisional application No. 63/548,903, filed on Feb. 2, 2024.

(51) Int. Cl. B01F 25/314; B01F 25/4314

(52) U.S. Cl. CPC B01F 25/3141; B01F 25/31423; B01F 25/4314

(57) ABSTRACT

A fluid mixer apparatus can include: a single-piece housing defining a fluid flow path configured for a first fluid through the single-piece housing; a fluid inlet defining on an exterior surface of the single-piece housing, the fluid inlet configured to receive a second fluid different from the first fluid; an inner chamber circumferentially defined inside the single-piece housing, the inner chamber configured to receive the second fluid from the first inlet; a central hub; and a plurality of helical airfoils coupled to an interior surface of the single-piece housing and the central hub, the plurality of helical airfoils being in fluid communication with the inner chamber. Each helical airfoil can include: a plurality of perforations in fluid communication with the inner chamber to introduce the second fluid into the first fluid; and an airfoil surface perturbation positioned adjacent to or rearward of the plurality of perforations.

### RELATED APPLICATIONS

This is a continuation-in-part of U.S. application Ser. No. 18/679,139 filed on 30 May 2024, now pending, which claims the benefit of U.S. Provisional Application No. 63/548,903 filed on 2 Feb. 2024, now pending. The contents of these disclosures are incorporated herein by reference in their entirety.

### FIELD

The described examples relate generally to mixing fluids.

### BACKGROUND

Fluids of all types are commonly delivered or transported in a variety of ways. Often, fluids are treated at some point in the delivery or transportation process (e.g., to facilitate subsequent refinement processes, storage, use, sale, or production). Treatment can include, for example, chemical treatment to remove, inoculate, dissolve, bind with, sanitize, purify, or alter certain fluid elements or fluid properties. For instance, treatment of water can include “hard” water treatment to remove certain minerals from the water and/or water purification treatment to eliminate at least a threshold amount of viruses and bacteria. As another example, iron distressed oil (e.g., with excess iron content) can undergo iron chelate treatment to reduce iron levels in the crude oil. Additionally or alternatively, dewatering or de-emulsifying solutions can be implemented. These and other conventional treatment processes can be expensive, time consuming, and inefficient. Common iron chelate treatment, for instance, can often entail 10-12 hours of treatment, including agitation steps, decant steps, testing, etc. Therefore, there is an ongoing need for improved systems, apparatuses, and methods of mixing fluids, including in applications for fluid treatment.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates to a fluid mixer apparatus. The fluid mixer apparatus can include a single-piece housing defining a fluid flow path for a first fluid through the single-piece housing, a fluid inlet defining on an exterior surface of the single-piece housing, the fluid inlet that can receive a second fluid different from the first fluid, an inner chamber circumferentially defined inside the single-piece housing, the inner chamber that can receive the second fluid from the first inlet, a central hub, and a plurality of helical airfoils coupled to an interior surface of the single-piece housing and the central hub, the plurality of helical airfoils being in fluid communication with the inner chamber. Each helical airfoil of the plurality of helical airfoils can include a plurality of perforations in fluid communication with the inner chamber to introduce the second fluid into the first fluid, and an airfoil surface perturbation positioned adjacent to or rearward of the plurality of perforations.

In some examples, the airfoil surface perturbation comprises a wavelet or a crested wavelet. The airfoil surface perturbation can extend from an inboard portion of the helical airfoil to an outboard portion of the helical airfoil. In one example, the plurality of perforations extends along a length of the airfoil surface perturbation, and when the first fluid flows over the airfoil surface perturbation, the first fluid forms an eddie and the second fluid is drawn out from the plurality of perforations to interact with the first fluid. In one example, the interaction of the first fluid and the second fluid are that can induce Von-Karman effects or wave vortices. In another example, the airfoil surface perturbation comprises a plurality of serrations along a trailing edge of the helical airfoil, and the plurality of serrations comprises a row of helical serrations. Each of the helical serrations of the row of helical serrations comprises a first helical portion protruding upward from the trailing edge and a second helical portion protruding downward from the trailing edge. In one example, each helical serration of the row of helical serrations extends rearward from the trailing edge of the helical airfoil. In certain examples, the central hub and the plurality of helical airfoils are integrally formed together as a single unit.

Another aspect of the present disclosure relates to a mixing device connectable to an open end of a pipe. The mixing device can include a unified housing defining a fluid flow path for a first fluid to move through the unified housing, a fluid inlet disposed on an exterior surface of the unified housing, the first fluid inlet can receive a second fluid different than the first fluid, a first inner chamber defined inside the unified housing, the first inner chamber can receive the second fluid from the fluid inlet, a second inner chamber defined inside the unified housing adjacent to the first chamber, the second chamber in fluid communication with the first inner chamber, and a plurality of airfoils coupled to the unified housing and positioned in the fluid flow path. Each airfoil of the plurality of airfoils can include a leading edge, a trailing edge positioned opposite of the leading edge, a top surface and a bottom surface opposite the top surface, a plurality of perforations defined at least by the top surface, the plurality of perforations in fluid communication with the second inner chamber, and a plurality of crested wavelets positioned adjacent to the plurality of perforations.

In one or more examples, the plurality of crested wavelets is positioned adjacent to the plurality of perforations to induce a first mixing event before the trailing edge. In one example, each airfoil of the plurality of airfoils comprises an airfoil surface perturbation positioned along the trailing edge. The airfoil surface perturbation positioned along the trailing edge can induce a second mixing event after the trailing edge. In another example, the first inner chamber can stabilize the pressure and flow of the second fluid received from the fluid inlet. The mixing device can further include a plurality of discrete connection ports fluidly connecting the first inner chamber and the second chamber. In one example, each airfoil of the plurality of airfoils comprises an interior portion defining a cavity in fluid communication with the second chamber and the plurality of perforations.

Yet another aspect of the present disclosure relates to a mixing device. The mixing device can include a housing. The housing can include a fluid intake, a first inner chamber in fluid communication with the fluid intake, and a second chamber in fluid communication with the first chamber. The mixing device can further include a plurality of airfoils affixed to the housing. Each airfoil of the plurality of airfoils can include a leading edge, a trailing edge positioned opposite of the leading edge and comprising a plurality of helical serrations, and a major surface extending between the leading edge and the trailing edge. The major surface can define a plurality of perforations in fluid communications with the second chamber, and a plurality of crested wavelets positioned on the major surface and adjacent to the plurality of perforations.

In some examples, the plurality of crested wavelets can induce fluid recursion leading into the plurality of helical serrations. The mixing device can further include a plurality of flow modifiers coupled to the housing extending radially inward. Each flow modifier of the plurality of flow modifiers can be respectively positioned between a pair of airfoils of the plurality of airfoils, and each flow modifier of the plurality of flow modifiers can define a perforation in fluid communication with the second chamber.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1-2 illustrate an example environment of a mixer apparatus in accordance with one or more examples of the present disclosure;

FIG. 3-8 respectively illustrate front perspective, rear perspective, front, rear, top, and side perspective views of an example mixer device in accordance with one or more examples of the present disclosure;

FIGS. 9-12 illustrate various cross-sectional views of the example mixer device of FIGS. 3-7, in accordance with one or more examples of the present disclosure;

FIG. 13 illustrates an example airfoil of a mixer device in accordance with one or more examples of the present disclosure;

FIGS. 14-15 illustrate another example airfoil of a mixer device in accordance with one or more examples of the present disclosure;

FIGS. 16-20 respectively illustrate front perspective, rear perspective, side perspective, and various cross-sectional views of another example mixer device in accordance with one or more examples of the present disclosure;

FIGS. 21-22 respectively illustrate front perspective and rear perspective views of yet another example mixer device in accordance with one or more examples of the present disclosure;

FIG. 23 illustrates an example mixer device in accordance with one or more examples of the present disclosure;

FIGS. 24-26 respectively illustrate front perspective, rear perspective, and cross-sectional views of another example mixer device in accordance with one or more examples of the present disclosure;

FIGS. 27A-27B respectively illustrate an isometric view and a side view of a fluid mixer apparatus in accordance with one or more examples of the present disclosure;

FIGS. 28A-28B respectively illustrate a front view and rear view of the fluid mixer apparatus shown in FIGS. 27A-27B, according to one or more examples of the present disclosure;

FIG. 28C illustrates a rear isometric cross-sectional view along cut line A-A of the fluid mixer apparatus shown in FIGS. 27A-27B, according to one or more examples of the present disclosure;

FIG. 28D illustrates a front isometric cross-sectional view along cut line E-E of the fluid mixer apparatus shown in FIGS. 27A-27B, according to one or more examples of the present disclosure;

FIG. 29 illustrates a perspective view of a helical airfoil in accordance with one or more examples of the present disclosure.

FIG. 30A illustrates a cross-sectional view along cut line C-C of FIG. 28A of the fluid mixer apparatus shown in FIGS. 27A-27B in accordance with one or more examples of the present disclosure;

FIG. 30B illustrates a cross-sectional view along cut line D-D of FIG. 28A of the fluid mixer apparatus shown in FIGS. 27A-27B in accordance with one or more examples of the present disclosure;

FIG. 31A illustrates a rear cross-sectional view along cut line B-B of the fluid mixer apparatus shown in FIGS. 27A-27B, in accordance with one or more examples of the present disclosure;

FIG. 31B illustrates a front cross-sectional view along cut line F-F of the fluid mixer apparatus shown in FIGS. 27A-27B, in accordance with one or more examples of the present disclosure; and

FIG. 31C illustrates a front perspective cross-sectional view along cut line B-B of the fluid mixer apparatus shown in FIGS. 27A-27B, in accordance with one or more examples of the present disclosure.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to mixer devices (e.g., a fluid mixer apparatus, a stationary mixing device for mixing fluids, an in-line fluid mixer, etc.). The mixer devices of the present disclosure are compatible with a variety of fluids, including fluids in various states, to induce mixing of two or more fluids. For instance, a fluid can include a gas, liquid, colloid, suspension, particulate fluid (e.g., with nanoparticles), ferro-fluid, etc. A fluid can also include various fluid properties (e.g., viscosity, temperature) and/or flow conditions, such as Newtonian, laminar, turbulent, or other flow types or conditions. A mixer device as disclosed herein can also be employed for many different flow rates, volume throughput requirements, etc. Similarly, a mixer device can be implemented in a wide variety of applications (e.g., inside a pipe, along a canal, between piping or hose connections, on a portable transportation vehicle or trailer, between reservoirs or tanks, etc.). A mixer device of the present disclosure can, thus, be implemented in a wide range of laboratory, industrial, and remote field uses. In specific implementations, a mixer device of the present disclosure can be adapted (e.g., geometries and structures tuned) for a particular fluid to be treated, including oil, gas, water, etc.

In at least some examples, a mixer device of the present disclosure can improve mixing and/or mixing efficiency relative to conventional mixing devices. For example, a mixer device of the present disclosure can reduce the time and/or fluid flow distance for homogeneous mixing of multiple fluids. As another example, a mixer device of the present disclosure can reduce or eliminate batch times, processing steps, intermediate storage reservoirs, reaction tanks, etc. that are typically implemented with conventional mixing devices and methods. Indeed, in some examples, a mixer device of the present disclosure can lend to improved efficiency of mixing, improved efficiency of space, pipe length, or equipment utilization, and/or improved cost efficiencies. In at least some instances, a mixer device of the present disclosure can be implemented with one or more fluids in-situ, during transport, at extraction, upon delivery, between storage tanks, etc. without conventional intermediate steps to induce mixing of fluids.

In these or other examples, a mixer device of the present disclosure includes a housing arranged with airfoils. The housing and the airfoils—although positionally fixed or stationary relative to each other and to a pipe (or other mounting application)—include a geometry and structural configuration that can efficiently and effectively induce mixing of fluids. The airfoils, for instance, can impart certain fluid conditions, flow patterns, relative differences in velocity, etc. Various airfoils can be utilized, including helical airfoils, arched (e.g., lenticular) airfoils, curved airfoils, linear airfoils, looped airfoils, or a combination thereof. In some instances, the airfoils can be substantially straight or linear. Similarly, various housing shapes and sizes can be implemented (e.g., depending on the mounting location and/or space constraints). For example, the housing can be circular, square, triangular, or other polygonal shape. Housing shapes and sizes can also be implemented based on manufacturing considerations, including scalability, configurability, production processes, etc.

In more detail, a first fluid (which can include one or more fluids referred to in combination as a “first fluid”) can enter through a main opening of the mixer device. Additionally, the mixer device can receive a second fluid (which can include one or more other fluids) for injecting into the first fluid. For example, the mixer device can include a fluid inlet (e.g., an inoculant inlet) into the inside of the housing—the fluid inlet being different from and fluidly separate from the main opening of the mixer device. The fluid inlet can be in fluid communication with perforations defined in the airfoils to allow the second fluid from inside the housing to exit out of the perforations and into the first fluid as the first fluid flows past the airfoils.

In one or more examples, a mixer device of the present disclosure can include airfoil surface perturbations. The term “airfoil surface perturbation” can refer to any element or portion of the airfoil surface that can perturb, modify, or enhance fluid flow. In certain examples, an airfoil surface perturbation can magnify fluid flow effects induced by other components, such as fluid flow effects induced by the airfoils themselves, so that interaction of fluids can be improved, increased, or maximized. In one or more examples, an airfoil surface perturbation can conserve fluid momentum and motion of fluids to amplify mixing effects. In some examples, an airfoil surface perturbation can control fluid flow, induce mixing, and/or generate flow patterns (e.g., vortices, flow recursion, etc.) or flow conditions in fluids that flow past an airfoil. In particular examples, an airfoil surface perturbation can include wavelets (e.g., ridges, bumps, protrusions, etc.). Additionally or alternatively, an airfoil surface perturbation can include serrations (e.g., feathers, fingers, slit portions, helical portions, Archimedean screw portions, etc.). Other airfoil surface perturbations are herein contemplated (e.g., cutaways, scallops, dimples, surface texturing, mesh overlays, flaps, ailerons, spoilers, rudders, kruegers, slats, stabilizers, winglets, trims, etc.). In these or other examples, airfoils surface perturbations can include positionally fixed or static elements. In certain implementations, however, airfoil surface perturbations can include control surfaces, actuatable portions, dynamic (movable) elements, responsive portions, etc. In at least some examples, an airfoil surface perturbation can move, mix, emulsify, or otherwise induce interactions between fluids in such a way that reduces or eliminates clogging, clumping, blocking, choking, building up, or damming of fluid flow—which may be helpful for fluids that are particularly dense, thick, creamy, viscous, dirty, full of particulate, sludge-like, gummy, sticky, gelatinous, pasty, etc. Certain geometries—like a dual-crested helical serration—can provide such enhanced mixing, emulsifying, and/or anti-clogging attributes to a fluid flow.

Other mixing components besides airfoils are contemplated in the present disclosure. For example, a mixer device can include one or more mixing components positioned in between airfoils. To illustrate, one or more mixing components can include a block, wedge, wall, shelf, protrusion, etc. extending from the housing surface. In certain examples, the one or more mixing components can redirect, funnel, or impose certain fluid flow characteristics. In specific implementations, the one or more mixing components can redirect fluid flow into one or more airfoils and/or their associated vortices and fluid mixing. In at least one example, the one or more mixing components can be fluidly coupled to a fluid input (e.g., an inoculant coursing through one or more interior channels, cavities, or reservoirs disposed inside the housing of the mixer device).

As mentioned above, a housing for the mixer device can include many different shapes, sizes, configurations, mounting locations, and production process arrangements. In one or more such examples of the present disclosure, a mixing device can optionally include a unified housing (e.g., a single-piece housing) integrally formed as a single unit. In some examples, a unified housing can include a housing that is formed as a unitary body, whole, undivided, seamless, without attachments or add-ons, devoid of component assembly, etc. In some examples, a unified housing can be formed via additive manufacturing, subtractive manufacturing, casting, molding, etc. The terms unified housing and single-piece housing should not be limited, however, to a housing that has only a single piece at the outset of assembly or manufacturing. Indeed, a unified housing or a single-piece housing can include multiple components that are configured/assembled together (whether by interlocking features, fasteners, adhesives, welds, attachment devices like clamps, or combinations thereof). For instance, in some examples, a unified housing can include a split housing with two or more pieces that thread together, bind together, are press-fit, etc. In some examples, a unified housing can include any type of coupling (e.g., slip couplings, threaded couplings, compression couplings), fittings, adapters, reducers, etc.

A unified housing can provide certain example advantages. For instance, a unified housing can simplify and improve manufacturability (and scaleability), such as by omitting points of attachment or assembly. Additionally or alternatively, a unified housing can obviate usage of seals (e.g., between pipe walls and a mixer apparatus), which seals can fail due to cracks, excessive fluid pressure, shrinkage and thermal expansion, abrasions, particle contamination, seal interference, etc. In certain examples, a unified housing can lend to improved user adaptation so that a mixer apparatus need not be inserted and fitted into a pipe, hose, or other application. Rather, a unified housing can easily be connectable to an open end of a pipe, a tube, or the like (e.g., via a V-band clamp connection). Additionally or alternatively, a unified housing can connect two discrete segments of a pipe, tube, etc. in a same or similar manner. Like an adapter, the unified housing can be configured to secure (e.g., universally in a plug-and-play fashion) to different mating flanges or couplings of a pre-existing pipe to enable universal or custom fitting of the unified housing. In this way, the unified housing can be fitted to secure into, for example, a plumbing application, a treatment application, or the like—but without needing to retrofit existing infrastructure, tooling, etc.

Those of ordinary skill in the art, having the benefit of this disclosure, will recognize that a unified housing can be implemented with a mixer device in a variety of ways. In some examples, a mixer device with airfoils can be formed integrally with the unified housing (e.g., as a single unit). However, the present disclosure is not so limited. Indeed, a mixer device with airfoils can be fitted inside, slipped inside, fastened to, compression sealed, press fit, or otherwise inserted into the interior of a unified housing at the time of assembly or when applied in the field. The level of manufactured integration of a mixer device with airfoils in relation to a unified housing can depend on the desired application, fluid flow, user needs, custom fittings, or combinations thereof.

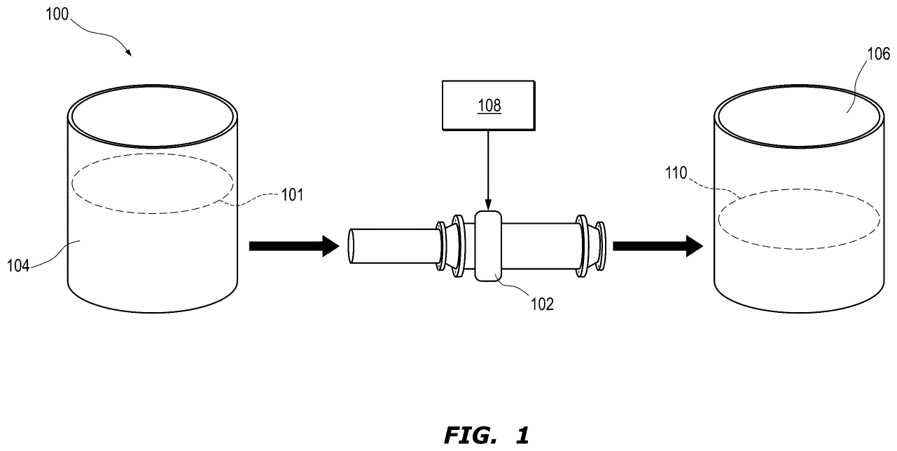

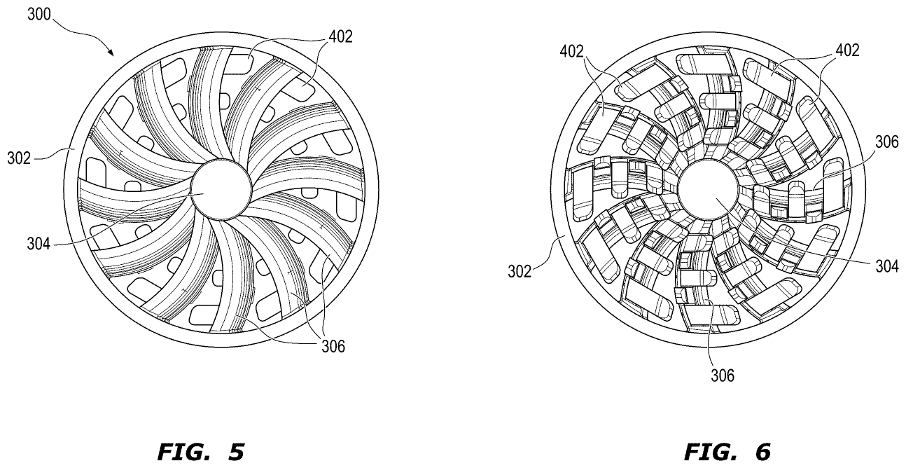

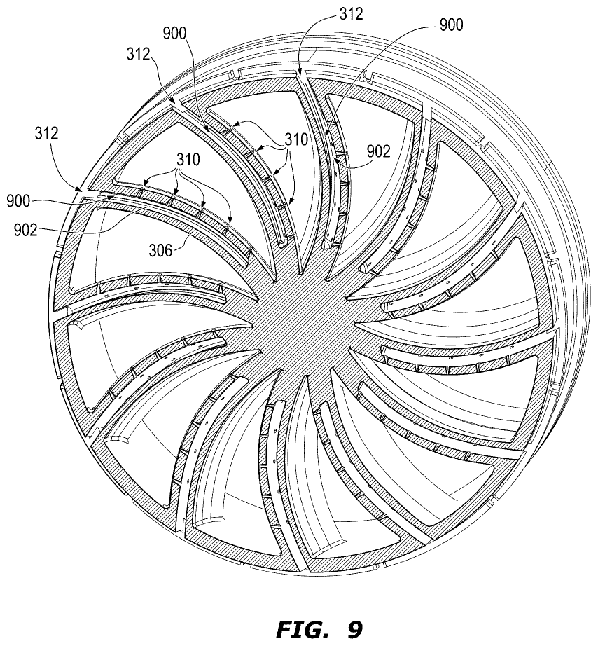

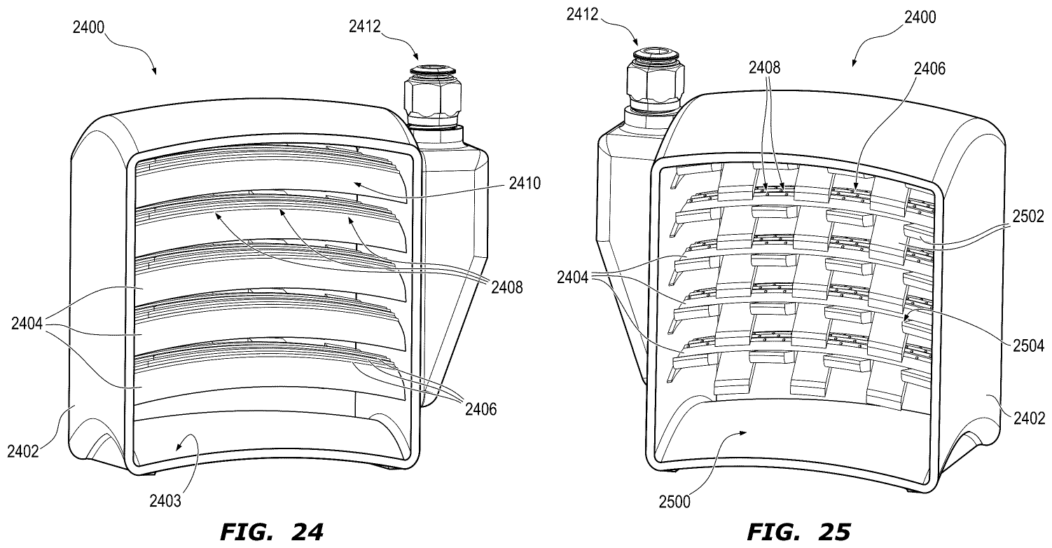

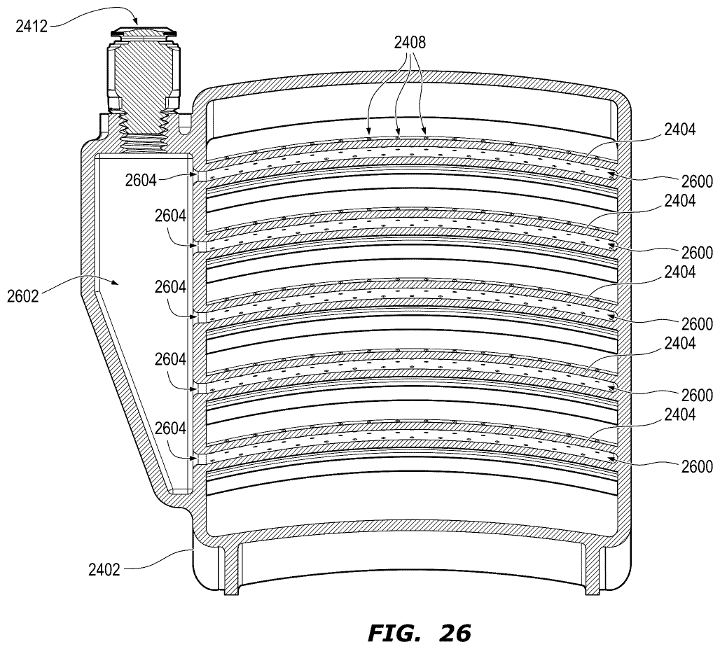

These and other examples are discussed below with reference to FIGS. 1-31C. However, a person of ordinary skill in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates an example environment 100 for a mixer apparatus 102 (depicted schematically) in accordance with one or more examples of the present disclosure. In particular, FIG. 1 illustrates a first fluid 101 (e.g., a single fluid or multiple different fluids) associated with a source 104. In particular examples, the first fluid 101 can include a fluid in a first state or condition (e.g., a raw state, a preprocessed state, a pretreated state, an unmixed state, a transport state, a temporary state, etc.). The source 104 can therefore include a reservoir (e.g., a tank, storage container, or fluid body). Additionally or alternatively, the source 104 can include an originating location, a mining location, an extraction site, a drill well, a holding location, a treatment plant, a transportation vehicle, a testing facility, a laboratory, upstream piping, upstream rivers (or streams, creeks, canals), etc. The source 104 in particular examples is not limited to originating sources (i.e., the furthest upstream source). The source 104 can include any number of downstream sources from an originating source. For example, the source 104 can include a waste water treatment plant or reservoir (notwithstanding the waste water may originate from sewer lines or drains leading into the waste water treatment plant).

The mixer apparatus 102, as will be described in relation to subsequent figures, can mix in a second fluid 108 with the first fluid 101 to produce a mixed fluid 110. In FIG. 1, the mixer apparatus 102 is depicted schematically. In particular, the mixer apparatus 102 can mix in the second fluid 108 with the first fluid 101 as the first fluid 101 flows into (or through) the mixer apparatus 102. That is, the first fluid 101 can flow directionally from the source 104 toward the mixer apparatus 102. In some examples, the first fluid 101 is pumped, forced, or pressured flowed into the mixer apparatus 102. In other examples, the first fluid 101 is gravity fed, naturally flowed, or unaltered in its flow into the mixer apparatus 102.

The second fluid 108 can include one or more fluids that differ from the first fluid 101. In some examples, the second fluid 108 can include an inoculant. In certain implementations, the second fluid 108 can include one or more of acids, asphalten removers, cleaners and degreasers, CO₂ scavengers, corrosion inhibitors, defoamers, dispersants, emulsion breakers, foaming agents, H₂S scavengers, microbicides, oxygen scavengers, paraffin (wax) inhibitors, paraffin solvents, salt inhibitors, scale inhibitors, scale removers, sulfur removers, surfactants, water purifying agents, water clarifiers, etc.

In turn, the mixed fluid 110 (e.g., a combination, mixture, solution, suspension, cleaned fluid, filtered fluid, treated fluid, etc.) including the first fluid 101 and the second fluid 108 can move from the mixer apparatus 102 to a destination 106. The destination 106 can include any downstream location relative to the mixer apparatus 102. The destination 106 is, therefore, not limited to an end source (i.e., the furthest downstream location or use of the mixed fluid 110). In some examples, the destination 106 can include a fluid body, temporary container, storage tank, reservoir, tanker trailer (or semi-truck trailer), facility, consumer location, municipal piping, industrial end user location, factory, refinery, laboratory, etc.

In these or other examples, the source 104 and the destination 106 can be at different (e.g., remote, off-site) locations. In particular examples, however, the source 104 and the destination 106 can be at a same location (e.g., same facility, same laboratory, same transportation vehicle, etc.), albeit separated at least by the mixer apparatus 102. For example, the mixer apparatus 102 can be implemented in an on-site dosing system in which the first fluid 101 (e.g., distressed oil) is pumped through the mixer apparatus 102 (where mixing occurs with the second fluid 108) to generate the mixed fluid 110 (e.g., iron-treated oil), which is pushed downstream. As another example, the mixer apparatus 102 can be implemented in a mobile dosing system—such as a tanker trailer—in which the first fluid 101 (e.g., distressed oil) is pumped from the source 104 (e.g., a distressed oil tank on the tanker trailer) through the mixer apparatus 102 (where mixing occurs with the second fluid 108) to generate the mixed fluid 110 (e.g., iron chelate treated oil). The mixed fluid 110 can then be pushed downstream to the destination 106 (e.g., a treated oil tank on the same tanker trailer as the distressed oil tank).

Regardless of where the source 104 and the destination 106 are, the mixer apparatus 102 can enable in-situ mixing of fluids without requiring separate batch treatments, agitation baths, testing, etc. In omitting these conventional mixing steps, the mixer apparatus 102 can lend to improved system efficiencies by “stacking” (i.e., simultaneously performing) mixing of fluids and en route fluid delivery (e.g., transportation, piping, pumping, storing, etc.).

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 1.

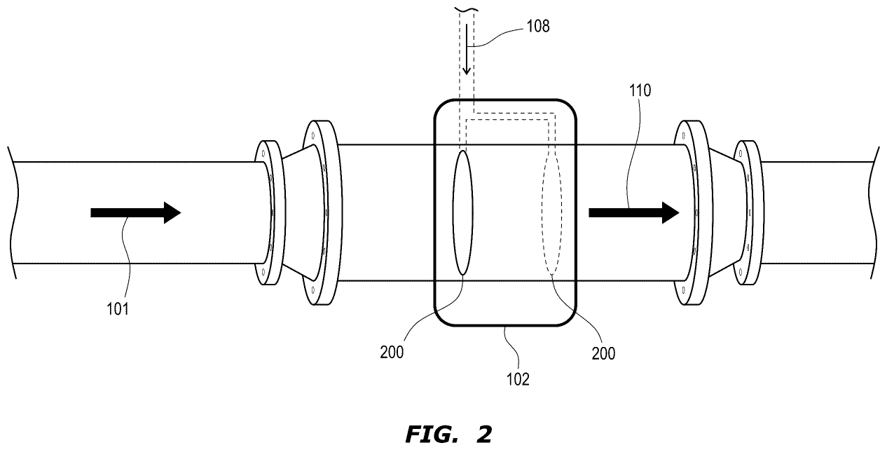

FIG. 2 illustrates a more detailed view of the environment 100, including the mixer apparatus 102, in accordance with one or more examples of the present disclosure. As shown in schematic form, the mixer apparatus 102 can include at least one mixer device 200. The mixer device 200 can receive the first fluid 101 and the second fluid 108 to generate the mixed fluid 110, as described above. For instance, the first fluid 101 can pass through the mixer device 200. As the first fluid 101 passes through the mixer device 200, the mixer device 200 can introduce the second fluid 108 into the first fluid 101 in such a way that causes the first fluid 101 and the second fluid 108 to thoroughly mix together, thereby creating the mixed fluid 110.

In FIG. 2, an optional second mixer device 200 is denoted via dashed lines. In such example embodiments including multiple mixer devices 200 (e.g., a first mixer device 200 and a second mixer device 200 placed in series to each other), each mixer device 200 can perform the same function as described above. The first fluid 101 can pass through the first mixer device 200. As the first fluid 101 passes through the first mixer device 200, the first mixer device 200 can introduce the second fluid 108 into the first fluid 101 in such a way that causes the first fluid 101 and the second fluid 108 to thoroughly mix together, thereby creating the mixed fluid 110. This portion of the mixed fluid 110 can then enter into the second mixer device 200. As the mixed fluid 110 enters into the second mixer device 200, more of the second fluid 108 can be introduced into the mixed fluid 110 and thoroughly mixed. Alternatively, as the mixed fluid 110 enters into the second mixer device 200, a third fluid (not shown) can be introduced into the mixed fluid 110 and thoroughly mixed to create a second mixed fluid. In this manner, mixing of multiple different inoculants can occur in stages using multiple, sequentially positioned mixer devices 200.

In these or other examples, multiple mixer devices 200 can be advantageous for improving mixing of fluids and/or for separately introducing (and mixing in) different inoculants. Multiple mixer devices 200 can be spaced apart or joined together, positionally offset (e.g., rotationally twisted relative to one or more other mixer devices 200), and/or arranged with differing structures (e.g., a first mixer device 200 with a first number of airfoils and a second mixer device with a differing number or differing geometry of airfoils). Multiple mixer devices 200 can also be advantageous for certain flow rates, volume throughput, and/or types of fluids. For example, multiple mixer devices 200 can be advantageous for higher flow rates and/or larger pipes (larger volume throughput) to help ensure thorough mixing of fluids. To illustrate, a 12-inch inner diameter pipe with water as the fluid may use two mixer devices 200, while a 2-inch inner diameter pipe with crude oil as the fluid may use a single mixer device 200. The number, arrangement, and structural configuration of the mixer devices 200 can thus vary widely based on the fluid and application of choice. In particular examples, the mixer apparatus 102 includes a single mixer device 200. In other examples, the mixer apparatus 102 includes multiple mixer devices 200 (e.g., 2 to 20 mixer devices, 4 to 18 mixer devices, 5 to 15 mixer devices, 7 to 12 mixer devices, or about 10 mixer devices).

Although FIG. 2 shows the mixer devices 200 positioned inside a pipe, the mixer devices 200 can be implemented in a wide variety of applications, as noted above. For example, the mixer devices 200 can be implemented in a canal, channel, or drain. The mixer devices 200 can also be implemented at (or along) fluid connections or fluid intersections. The mixer devices 200 can be positioned at open ends (e.g., connected to open ends of pipes, hoses, conduits, etc.). The mixer devices 200 do not require a closed-environment or an open environment and can thus be adapted for a wide variety of positional applications. Indeed, the mixer devices 200 can be modular in nature (e.g., stacked, positioned in series with each other, or adapted for versatile and custom applications) allowing the first fluid 101 to flow freely through and over the mixer device structure and evenly mix with or contact the second fluid 108—regardless of application.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 2.

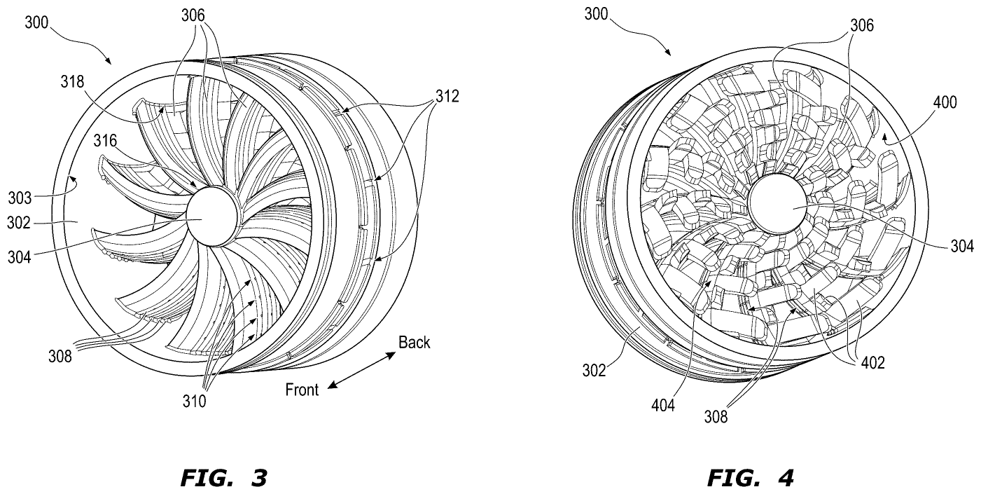

FIGS. 3-6 illustrate a mixer device 300 in accordance with one or more examples of the present disclosure. The mixer device 300 can be the same as or similar to the mixer devices 200 described above.

As shown, the mixer device 300 can include a housing 302. The housing 302 can include a framework, shell, body structure, or enclosure of the mixer device 300. The housing 302 can include a variety of shapes and sizes (e.g., depending on the application of the mixer device 300). In particular examples, the housing 302 includes an annular ring, cylinder, or torus. In these or other examples, the housing 302 can define a main opening 303 through which fluid (e.g., the first fluid 101 discussed above) can enter and an exit opening 400 through which a combination of fluids (e.g., the mixed fluid 110 discussed above) can exit the mixer device 300. In some examples, the main opening 303 is sized and shaped the same as or similar to the exit opening 400.

The mixer device 300 can additionally include airfoils 306. The term “airfoil” can include a shaped member to impart fluid properties and/or leverage fluid mechanics in a fluid system. In some examples, an airfoil includes a shaped member that induces a faster fluid velocity over a first surface and a slower fluid velocity over a second surface. An airfoil can cause a fluid to move in certain patterns or generate fluid interactions. An airfoil, for example, can separate oncoming fluid into discrete mixing portions that can receive or mix with an inoculant or second fluid (as will be described below). In particular, an airfoil can include a leading edge (e.g., a leading edge 314) that splits oncoming fluid into a first fluid portion that flows faster across the top surface of the airfoil and a second fluid portion that flows slower across the bottom surface. The leading edge of an airfoil and a trailing edge of an airfoil are contiguous with the major airfoil surfaces (e.g., the top and bottom surfaces of the airfoil).

The airfoils 306 can have a variety of sizes and shapes. For example, the airfoils 306 can be helical (as shown), arched (e.g., lenticular, as shown in FIGS. 24-26), curved, linear, looped, or a combination thereof. Airfoil sizes (e.g., airfoil thickness between top and bottom surfaces, airfoil width between a leading edge 314 and trailing edge 404, or airfoil length between an inboard portion 316 and an outboard portion 318) can be tuned based on fluid properties, flow rate, volume throughput, desired mixing level (i.e., degree of mixing completeness). Similarly, airfoil pitch (e.g., angle of attack of the leading edge 314) and airfoil curvature or geometry can affect desired mixing levels subject to fluid properties, flow rate, volume throughput, etc. A quantity of the airfoils 306 (and/or spacing between each of the airfoils 306) can also be tuned or optimized for desired mixing levels, fluid properties, flow rate, volume throughput, etc. Indeed, although shown as including 12 airfoils, the airfoils 306 can include more or fewer airfoils (e.g., between 2 airfoils and 30 airfoils, between 4 airfoils and 25 airfoils, between 8 airfoils and 20 airfoils, or about 15 airfoils).

The airfoils 306 can fixedly attach to the housing 302 and a central hub 304 (e.g., a core portion, center mount, middle anchor, main shaft, nose, etc.). That is, the airfoils 306 in some examples are, unlike a turbine or propeller, immovable relative to the housing 302 (and the central hub 304). The airfoils 306, in some examples, are thus positionally fixed at both ends. Specifically, the inboard portion 316 (e.g., the innermost end portions of the airfoils 306) can be fixed to the central hub 304, and the outboard portion 318 (e.g., the outermost end portions of the airfoils 306) can be fixed to the housing 302.

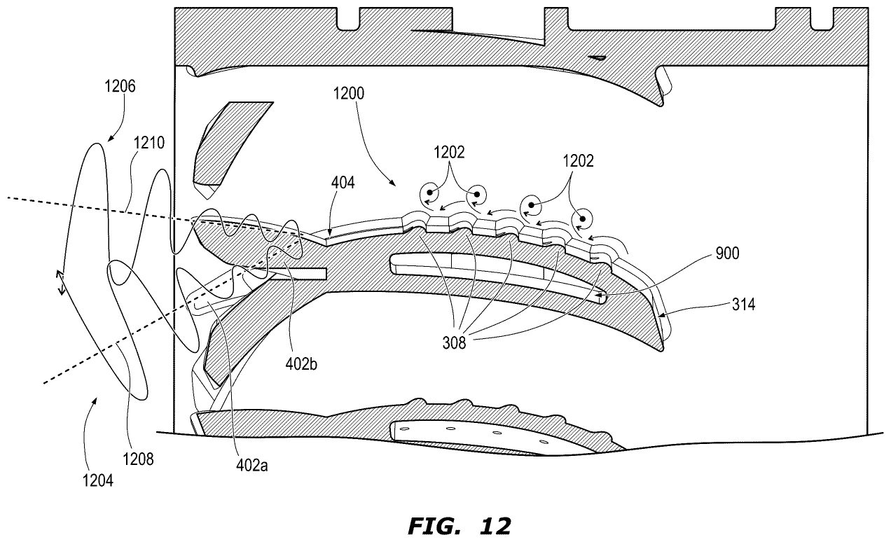

In some examples, the airfoils 306 can include airfoil surface perturbations 308. The airfoil surface perturbations 308 can, in particular examples, include wavelets (e.g., ridges, bumps, protrusions, etc.). The airfoil surface perturbations 308 can be rounded or curved in some examples. Additionally or alternatively, the airfoil surface perturbations 308 can include corners, vertices, or edges. In some examples, the airfoil surface perturbations 308 can generate certain flow patterns and/or flow conditions for a fluid passing over and/or around the airfoil surface perturbations 308. In specific examples, the airfoil surface perturbations 308 can induce flow recursion (as will be discussed below in relation to FIG. 12). In these or other examples, the airfoil surface perturbations 308 can help mix in a second fluid (or inoculant) with a first fluid proceeding through the main opening 303.

The airfoil surface perturbations 308 can be arranged in a variety of configurations according to fluid properties, flow rate, volume throughput, desired mixing levels, etc. In some examples, a structural configuration (e.g., a geometry or arrangement) of the airfoil surface perturbations 308 (and/or the airfoil surface perturbations 402 described below) can be tuned to a specific fluid. For instance, the geometry of the airfoil surface perturbations 308 can be tuned to the flow characteristics of the oncoming fluid to enter through the main opening 303 and/or the inoculant to be introduced via the airfoils 306.

In some examples, the airfoil surface perturbations 308 are positionally arranged perpendicular to the fluid flow path coming into the main opening 303. That is, the airfoil surface perturbations 308 can be positioned along a top (and/or bottom) surface of the airfoils 306 in a lengthwise fashion, extending at least partially between the inboard portion 316 and the outboard portion 318. In particular examples, the airfoil surface perturbations 308 extend an entire length of the airfoils 306 between the inboard portion 316 and the outboard portion 318.

In one or more examples, the airfoil surface perturbations 308 can include a series of wavelets (e.g., multiple rows of wavelets) on a given airfoil surface. For example, and as shown, the airfoil surface perturbations 308 can include a series of wavelet rows aligned one after (or rearward of) the other. In alternative examples, the airfoil surface perturbations 308 can include offset or staggered rows such that there is only partial overlap between subsequent wavelet rows (e.g., a first wavelet row extends from the inboard portion 316 toward a portion just past the middle of the airfoil, and a second wavelet row extends from the outboard portion 318 toward a portion just past the middle of the airfoil, thereby creating wavelet “overlap” in a middle section of the airfoil).

The individual rows of the airfoil surface perturbations 308 can also include a variety of configurations. In some examples, the individual rows of the airfoil surface perturbations 308 follow a single, straight path along the airfoil surface. In other examples, the airfoil surface perturbations 308 include other configurations (e.g., zig-zag configurations, pointed V-shape configurations, etc.). A given wavelet row of the airfoil surface perturbations 308 can also be discontinuous (e.g., a line of discrete protuberances, risers, bulges, projections, etc. that are interspaced by unperturbed airfoil surface). As a whole, each of the airfoil surface perturbations 308 can be structurally configured or arranged in the same way. Alternatively, the airfoil surface perturbations 308 can differ from row to row of wavelets, alternate between row configurations, etc. (e.g., a first zig-zag row, a second straight row, a third zig-zag row, a fourth straight row, and so forth).

In some examples, the airfoils 306 can include perforations 310. The perforations 310 can include openings, slits, through-holes, etc. that extend from the outer surface of the airfoils 306 to an interior portion defining an inner channel or cavity (shown in FIG. 9). In these or other examples, the perforations 310 fluidly connect an interior portion of the airfoils 306 and an exterior portion of the airfoils 306. In addition, the perforations 310 can be in fluid communication with fluid inlets 312. In this manner, a fluid (e.g., an inoculant) can pass into the fluid inlets 312, through an interior cavity of the airfoils 306, and out through the perforations 310 to mix with another fluid passing into the main opening 303 and across the airfoils 306.

The perforations 310 can be arranged in a variety of different ways depending on fluid properties, flow rate, volume throughput (e.g., of inoculant), desired mixing levels, etc. The perforations 310 can be defined by any major surface (e.g., the top surface and/or the bottom surface) of the airfoils 306. In specific examples, the perforations 310 are defined by the same airfoil surface as the airfoil surface perturbations 308. For example, the perforations 310 can be positioned adjacent to (e.g., on the airfoil surface perturbations 308, immediately in front of the airfoil surface perturbations 308, immediately behind or rearward of the airfoil surface perturbations 308, etc.). In specific implementations, the perforations 310 are positioned along a length of the airfoil surface perturbations 308. In other examples, the perforations 310 are positioned spaced apart from the airfoil surface perturbations 308 (e.g., rearward of and approximately halfway between wavelet rows). A perforation density, size (e.g., diameter), and/or spacing of the perforations 310 can also affect desired mixing levels and/or inoculant volume throughput. In some examples, the perforation density, size, and/or spacing of the perforations 310 can also affect fluid pressurization of the inoculant. Thus, in some embodiments, fluid pressurization to force fluid out through the perforations 310 can be tuned based on the density, size, and/or spacing of the perforations 310 (among other factors, such as fluid viscosity, resonance frequency of one or more fluids, interior airfoil cavity volume, fluid inlet size, etc.).

In at least some examples, the fluid housed within the interior portion of the housing 302 and the airfoils 306 has a greater fluid pressure than the fluid pressure in the ambient environment of the mixer device 300 at the perforations 310. The pressure differential can, as noted above, force the inoculant inside the airfoils 306 to proceed out through the perforations 310 rather than allowing ambient fluid passing over the airfoils 306 to enter into the perforations 310. In some examples, the pressure differential can range from about 2 pounds/square inch (PSI) to about 50 PSI, about 5 PSI to about 40 PSI, about 8 PSI to about 16 PSI, about 10 PSI to about 25 PSI, or about 30 PSI to about 40 PSI.

As shown in FIGS. 4-6, the mixer device 300 can, in some examples, include airfoil surface perturbations 402 extending from the trailing edge 404. In certain examples, the airfoil surface perturbations 402 can segment the air or fluid flow from the airfoils such that vortices are formed as the fluid(s) depart the mixer device 300 in, over, and/or around the airfoil surface perturbations 402. The airfoil surface perturbations 402 can include serrations (e.g., feathers, fingers, slit portions, etc.). The airfoil surface perturbations 402 (as depicted) can be positioned rearward (i.e., behind) the airfoil surface perturbations 308 and the perforations 310. In some examples, and as shown, the airfoil surface perturbations 402 can be pitched out of plane relative to the trailing edge 404 (where “out of plane” refers to a relative non-planar positioning). In some examples, the airfoil surface perturbations 402 can alternate in pitch direction along the trailing edge 404 (e.g., a first serration angled up from the trailing edge 404, a second serration angled down from the trailing edge 404, a third serration angled up, a fourth serration angled down, and so forth). In these or other examples, alternating pitch angles of the airfoil surface perturbations 402 can help induce interacting vortices in the fluid flow to aid mixing (as will be described more below in relation to FIG. 12).

In at least some examples, the pitch angle of the airfoil surface perturbations 402 relative to the trailing edge 404 can vary between the inboard portion 316 and the outboard portion 318. For instance, the pitch angle of the airfoil surface perturbations 402 can progressively increase from the inboard portion 316 to the outboard portion 318 (e.g., from about 2 degrees to about 90 degrees, about 4 degrees to about 75 degrees, about 5 degrees to about 50 degrees, about 8 degrees to about 30 degrees, about 10 degrees to about 25 degrees, or about 5 degrees to about 30 degrees). In other instances, the pitch angle of the airfoil surface perturbations 402 can progressively decrease from the inboard portion 316 to the outboard portion 318, as spatial constraints may permit.

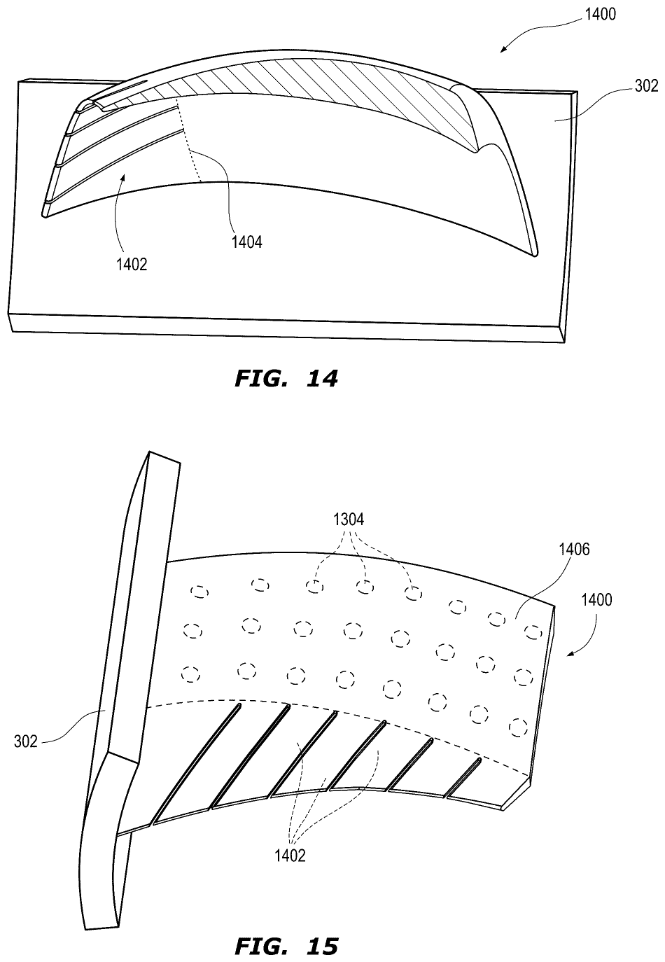

In these or other examples, progressively changing pitch angles of the airfoil surface perturbations 402 can also aid mixing by inducing interacting vortices in the fluid flow and/or by varying exiting fluid velocities and flow patterns in fluids that leave through the exit opening 400. In some examples, progressively changing pitch angles of the airfoil surface perturbations 402 can also ensure mixing of fluids with fluid portions that travel along the underside of an airfoil (e.g., to mix up fluids forming a boundary layer along the underside of the airfoils 306 that may not have the airfoil surface perturbations 308 to induce mixture). In yet another example, progressively changing pitch angles of the airfoil surface perturbations 402 can mix up fluids flowing in regions interspaced between the airfoils 306 (and not necessarily across or along an airfoil surface). Alternatively, in some examples (e.g., as shown in FIGS. 14-15), the airfoil surface perturbations 402 are not pitched out of plane relative to the trailing edge 404.

Further, in some examples, a serration length (e.g., the finger length or distance from the serration tip to the trailing edge 404) of the airfoil surface perturbations 402 can vary between the inboard portion 316 and the outboard portion 318. For instance, the serration length of the airfoil surface perturbations 402 can progressively increase from the inboard portion 316 to the outboard portion 318 (e.g., from about 2 mm to about 100 mm, about 4 mm to about 75 mm, about 5 mm to about 50 mm, about 8 mm to about 30 mm, about 10 mm to about 35 mm, or about 15 mm to about 25 mm). In other instances, the serration length of the airfoil surface perturbations 402 can progressively decrease from the inboard portion 316 to the outboard portion 318, as spatial constraints may permit. In some examples, the serrations can be longer (or larger) toward the outboard portion 318 because more volume of fluid can tend to flow through the larger gaps between the airfoils 306 (e.g., where the larger gaps are closer to the outboard portion 318 than the inboard portion 316) and thus longer serrations near the outboard portion 318 can be proportionally sized for greater mixing of a greater localized volume throughput than may occur at the inboard portion 316. Numerical methods or simulation may be used to tune these features for mixing of certain fluids (e.g., according to fluid properties, such as the viscosity, miscibility, resonance, or natural frequency of a fluid). In some examples, resonance of a fluid can be specifically addressed by tuning the geometry of the airfoil surface perturbations 402 to introduce a harmonic, or anti-resonance frequency, to the flow.

In addition to pitch angle and serration length, the airfoil surface perturbations 402 can include a wide variety of different configurations also dependent on fluid properties, flow rate, volume throughput, desired mixing levels, etc. For example, the airfoil surface perturbations 402 can include various different spacing or feather density. As another example, the airfoil surface perturbations 402 can be positioned along an entirety of the trailing edge 404, while in other examples only along a portion of the trailing edge 404. The airfoil surface perturbations 402 can also include a variety of different geometries. In some examples, and as shown, the airfoil surface perturbations 402 are curved. In other examples, the airfoil surface perturbations 402 can be straight, have discrete linear segments (e.g., a first segment at a first angle relative to the trailing edge 404 and a second segment at a second angle relative to the trailing edge 404), include twisted portions (e.g., helical portions), include multi-directional portions (e.g., a first portion parallel to fluid flow and a second portion perpendicular to fluid flow), etc. Still, in other examples, the airfoil surface perturbations 402 can include biomimicry designs (e.g., as adapted from certain feathers of birds of prey). In such designs, fluid flow (e.g., air flow) can be modified to increase or decrease fluid flow efficiency by tuning structural aspects, such as geometry or angle of attack, to achieve a specific flow result.

In one or more examples, the airfoil surface perturbations 402 include static or fixed members relative to the airfoils 306. That is, the airfoil surface perturbations 402 can be positionally immovable or rigid. In some examples, the airfoil surface perturbations 402 can be flexible, bendable, or pliant (e.g., to dynamically maintain homogeneity of mixing in response to changing fluid conditions). In particular examples, the airfoil surface perturbations 402 can be moldable or conformable to user adjustments (e.g., for in-field modifications). In other examples, the airfoil surface perturbations 402 can be manipulated or actuated. For example, the airfoil surface perturbations 402 can be actively actuated via wire tensioning, motor control, etc. In some examples, the airfoil surface perturbations 402 can be actuated in response to thermal activation (e.g., via thermally activated serration materials, such as Nitinol).

Any of the features, components, and/or parts, including the arrangements and configurations thereof shown in FIGS. 3-6 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 3-6.

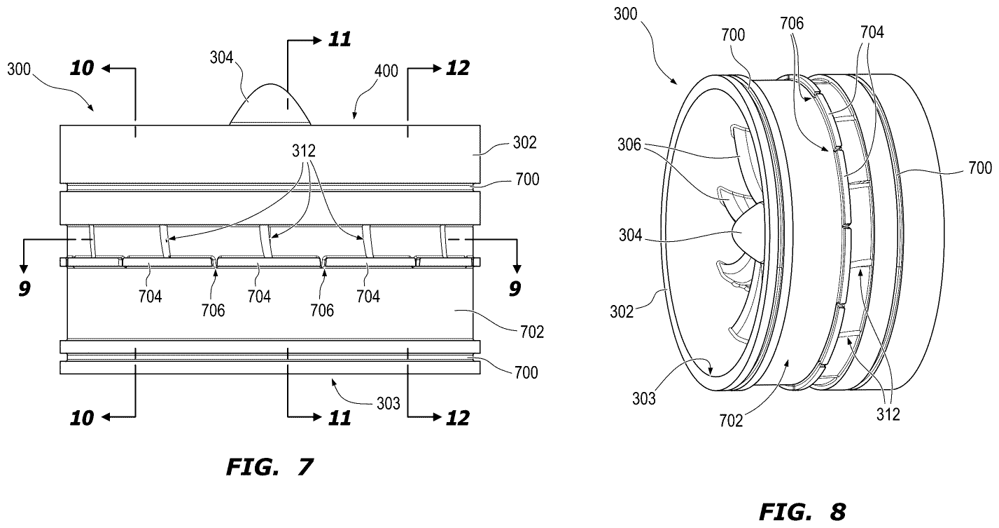

FIGS. 7-11 illustrate additional views of the mixer device 300 in accordance with one or more examples of the present disclosure. As shown, the mixer device 300 can include seal channels 700. The seal channels 700 can include grooves, indentations, notches, or seating portions that extend about the housing 302. In some examples, the seal channels 700 are sized and shaped to receive O-rings or other sealing components (not shown) that can engage the inner wall of a pipe, conduit, channel, etc. in which the mixer device 300 is placed. In this manner, the exterior portion of the housing 302 between the seal channels 700 can be fluidly sealed from the ambient environment. In so doing, fluid is disallowed from bypassing the main opening 303. That is, a seal within the seal channels 700 can prevent fluid from going around the mixer device 300 rather than through the mixer device 300 via the main opening 303 and out of the exit opening 400.

Additionally or alternatively, a seal disposed within the seal channels 700 (and seated against a pipe sidewall, for instance) can enable a second fluid (or inoculant) to be pressurized and forced into the fluid inlets 312—thereby enabling the pressure differential discussed above. For example, a second fluid can be injected into an injection cavity 702 positioned between the seal channels 700. A seal within the seal channels 700 having a sealing engagement with a pipe or other ambient environment component can prevent escape of the second fluid beyond the seal channels 700. Thus, with fluid pressure, the second fluid can be forced into the injection cavity 702 and subsequently into the fluid inlets 312 via slots 706 defined in ribs 704.

In particular examples, the ribs 704 (e.g., risers, protrusions, projections, etc.) can separate the injection cavity 702 from the fluid inlets 312 to at least partially direct (and more evenly control) fluid from the injection cavity 702 into the fluid inlets 312. In some examples, the ribs 704 are circumferentially disposed about the housing 302. In some examples, the ribs 704 can also be sized and shaped to engage (e.g., contact or abut against) a pipe sidewall. In other examples, the ribs 704 can be sized and shaped for positioning adjacent to or in close proximity to a pipe sidewall.

As mentioned, the ribs 704 can control (or more evenly spread) fluid ingress from the injection cavity 702 into the fluid inlets 312. Thus, in some examples, the slots 706 of the ribs 704 can be positioned offset relative to the fluid inlets 312 (e.g., at approximately halfway between the fluid inlets 312). In one or more examples, a positional offset of the slots 706 relative to the fluid inlets 312 can improve fluid spread or consistency of fluid volume injected into each of the fluid inlets 312 (rather than some of the fluid inlets 312 receiving more or less inoculant than other fluid inlets 312).

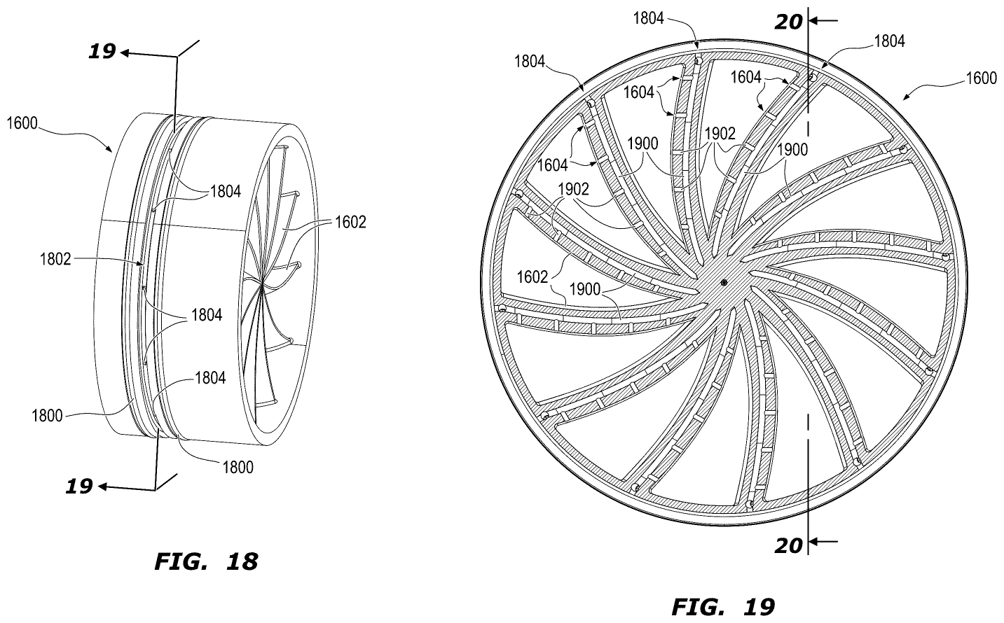

As shown in FIG. 9, injected fluid (e.g., inoculant) can enter the fluid inlets 312 and into a cavity 900 defined by an interior portion 902 of each of the airfoils 306. The cavity 900 can include a hollowed-out section, empty core, or internal volume in each of the airfoils 306, where the interior portion 902 (e.g., the interior airfoil surfaces) define the metes and bounds of the cavity 900. In some examples, the cavity 900 extends substantially between the leading edge 314 and the trailing edge 404. In other examples, the cavity 900 includes a central artery or channel, from which smaller capillaries can feed into the perforations 310 (as discussed below in relation to FIG. 19).

Once the fluid injected into the fluid inlets 312 enters the cavity 900, the fluid can spread throughout the cavity 900. In particular examples, the cavity 900 is pressurized at a positive pressure that is greater than a fluid pressure at the top surface of the airfoil (e.g., the ambient fluid pressure of the oncoming first fluid through the airfoil). The fluid can, with a sufficient positive pressure differential exceeding the ambient fluid pressure, then exit the airfoils 306 through the perforations 310. In particular examples, a positive pressure differential can also help to accurately meter (e.g., control, throttle, or balance) a throughput volume of the inoculant out through the perforations 310 while also helping to prevent backflow of the first fluid into the perforations 308.

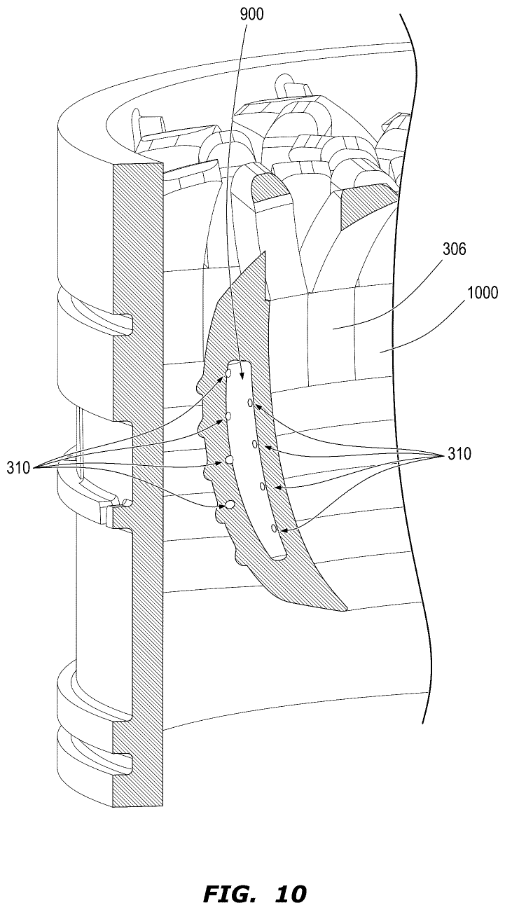

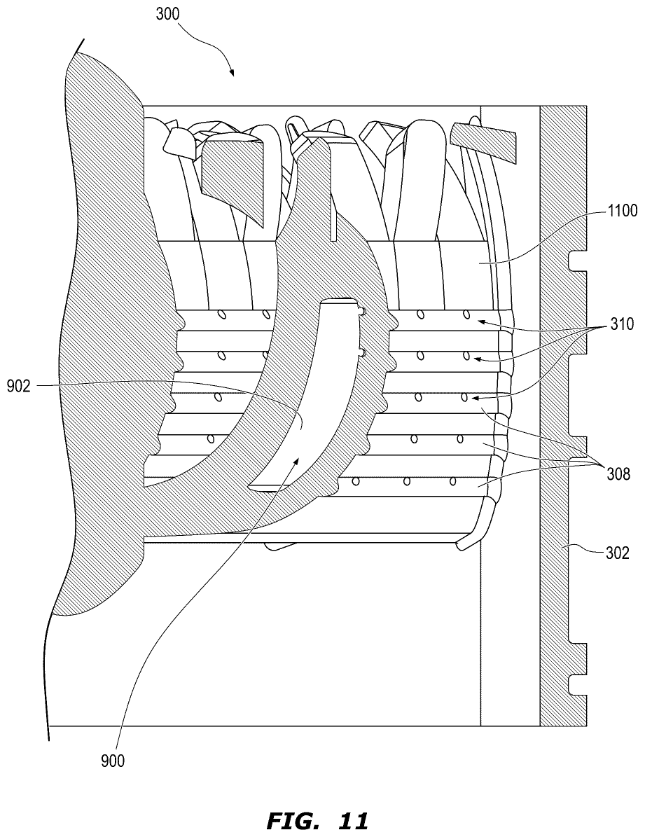

Indeed, as shown in FIGS. 10-11 respectively depicting bottom perspective and top perspective cross-sectional views of one of the airfoils 306, fluid can leave the cavity 900 and exit the airfoil 306 through the perforations 310 defined in a top surface 1100 opposite a bottom surface 1000 of the airfoil 306. As the fluid exits the perforations 310, mixing can occur along the airfoil surface perturbations 308 and the airfoil surface perturbations 402 (as discussed above, and as will be described in greater detail below in relation to FIG. 12).

Any of the features, components, and/or parts, including the arrangements and configurations thereof shown in FIGS. 7-11 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 7-11.

FIG. 12 illustrates a cross-sectional view of an airfoil and mixing events associated therewith in accordance with one or more embodiments of the present disclosure. As used herein, the term “mixing event” can refer to any mixing of two or more fluids. In particular examples, which will now be discussed, are mixing events that can occur in relation to one or more airfoil surface perturbations (specifically the airfoil surface perturbations 308 and the airfoil surface perturbations 402).

A first mixing event can include fluid recursion 1200 that can occur as oncoming fluid hits the leading edge 314 and begins to pass over the airfoil surface perturbations 308 (and as inoculant proceeds from the cavity 900 out of the perforations 310). In particular, fluid recursion 1200 can include fluid eddies that rise upward and roll backward onto themselves about rotational axes 1202. For instance, the shape, curvature or flow impediment provided by the airfoil surface perturbations 308 can cause the fluid eddies to form and proceed over the airfoils 306 (e.g., between the leading edge 314 the trailing edge 404). Additionally or alternatively, the positioning and orientation of the perforations 310 can aid formation of the fluid eddies as inoculant proceeds out of the perforations 310 at a non-parallel angle relative to the fluid flow over the airfoils 306. The fluid eddies can, in some examples, compound or interact with each other. In at least one example, the fluid eddies in the fluid recursion 1200 can create motive flow whereby the second fluid is pulled or drawn out from the perforations 310 and into the first fluid (thus reducing the pumping energy or pressurization for introducing the second fluid into the first fluid for mixing). In particular examples, the fluid eddies can mix together the inoculant and the oncoming fluid. In these or other examples, the first mixing event as just described occurs (or at least begins) as fluid crosses over the airfoil 306 before reaching the trailing edge 404.

A second mixing event can occur after the trailing edge 404. In particular, the second mixing event can include various vortices that form as the fluid recursion 1200 leads into the trailing edge 404 and across the airfoil surface perturbations 402. In some examples, a second mixing event can include vortices (e.g., swirls) that occur after or behind the trailing edge 404. For instance, a first airfoil surface perturbation 402a can induce a first vortex 1204 having a rotational axis 1208, and a second airfoil surface perturbation 402b can induce a second vortex 1206 having a rotational axis 1210. In these or other examples, the rotational axes 1208, 1210 for the second mixing event can be perpendicular to the rotational axes 1202 of the first mixing event. Additionally, in some examples, the vortices 1204, 1206 can be interacting vortices. For example, the vortices 1204, 1206 can include tight, small flow fields adjacent to the tips of the airfoil surface perturbations 404a, 404b that gradually become larger and larger until the vortices 1204, 1206 interact (e.g., cross into or intersect one another) at farther distances way from the tip-ends of the airfoil surface perturbations 404a, 404b.

In these or other examples, the first mixing event and the second mixing event can be tuned and optimized according to fluid properties, flow rate, volume throughput, desired mixing levels, etc. To do so, the airfoil surface perturbations 308 and the trailing edge 404 can be structurally predetermined, modified, custom tailored, tested, simulated, and/or certified to induce a desired mixing level based on certain flow conditions.

Any of the features, components, and/or parts, including the arrangements and configurations thereof shown in FIG. 12 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 12.

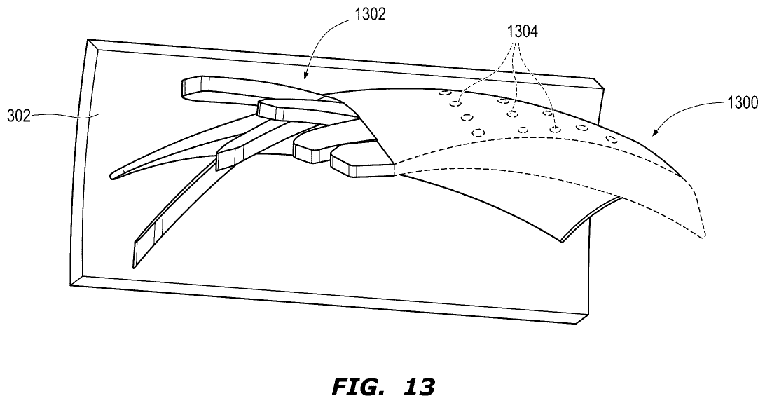

The foregoing figures (specifically FIGS. 3-12) illustrate one example of a mixer device. The present disclosure is not so limited, however. Indeed, the present disclosure contemplates many variations and modifications to the mixer device 300 that fall within the scope of this application. For example, any of the foregoing features (including the structural configurations, geometries, and arrangements) of a disclosed mixer device described above can modified, tuned or optimized for a specific use environment and/or a particular fluid application. As used herein, the term “optimize” should be interpreted to mean “improved,” “enhanced” or “local optima,” and not necessarily as “absolute optima,” “true optimization” or the “best,” although an “absolute optima” or “best” may still be covered by the present disclosure. For example, an optimization process (e.g., a simulation, fluid flow analysis, etc.) may improve upon a previous solution, may find the best solution, or may verify that an existing solution is a “local optima” or an “absolute optima” and thus should not be modified or changed. The following description with respect to FIGS. 13-26 briefly describes a few such example mixer devices.

In some examples, an airfoil can include serrations but omit at least one of perforations or wavelets. In accordance with one or more such examples, FIG. 13 illustrates an example airfoil 1300 of another example mixer device. For purposes of illustration, only a portion of the mixer device housing is shown that connects to an outboard portion of a single airfoil (i.e., the airfoil 1300). As shown, a mixer device can include one or more airfoils structured like the airfoil 1300, which includes serrations 1302. The serrations 1302 can be the same as or similar to the airfoil surface perturbations 402 described above. Optionally, the airfoil 1300 can include perforations 1304, which can be the same as or similar to the perforations 310 described above for introducing and mixing in an inoculant. Unlike the airfoils 306 described above, however, the airfoil 1300 may not include wavelets disposed on a major surface of the airfoil 1300. In these or other examples, a mixing event can occur at the serrations 1302 in a manner similar to the second mixing event with interacting vortices described above in relation to FIG. 12.

Any of the features, components, and/or parts, including the arrangements and configurations thereof shown in FIG. 13 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 13.

As described in conjunction with FIG. 13, some example mixer devices include airfoils that do not include wavelets. Additionally, in some examples, a mixer device can include airfoils in which the serrations are not pitched out of plane relative to the trailing edge and, instead, generally follow the overall curvature of the major surfaces of the airfoil. In accordance with one or more such examples, FIGS. 14-15 respectively illustrate side and top views of an example airfoil 1400 of yet another mixer device. For purposes of illustration, only a portion of the mixer device housing is shown that connects to an outboard portion of a single airfoil (i.e., the airfoil 1400).

As shown, the airfoil 1400 can include serrations 1402 (and optionally, the perforations 1304). Similar to the airfoil surface perturbations 402 and the serrations 1302, the serrations 1402 can gradually increase in length from the inboard portion to the outboard portion. The serrations 1402 can also include similar discrete fingers or members, which can be spaced apart from adjacent serration members. Unlike the airfoil surface perturbations 402 and the serrations 1302 depicted in the foregoing figures, however, the serrations 1402 are in-plane with a trailing edge 1404 and a top surface 1406. The serrations 1402 are not alternately angled relative to each other. In particular, the serrations 1402 are not angled differently relative to the trailing edge 1404 and the top surface 1406. The serrations 1402 instead continue to follow the curvature of the top surface 1406 after the trailing edge 1404. In these or other examples, a modified mixing event can occur at the serrations 1402. For example, the slots or gaps (which can be tuned for optimized mixing performance) between individual serration members of the serrations 1402 can induce desired mixing, in addition to the mixing that occurs as fluids cross over and between airfoils.

Any of the features, components, and/or parts, including the arrangements and configurations thereof shown in FIGS. 14-15 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 14-15.

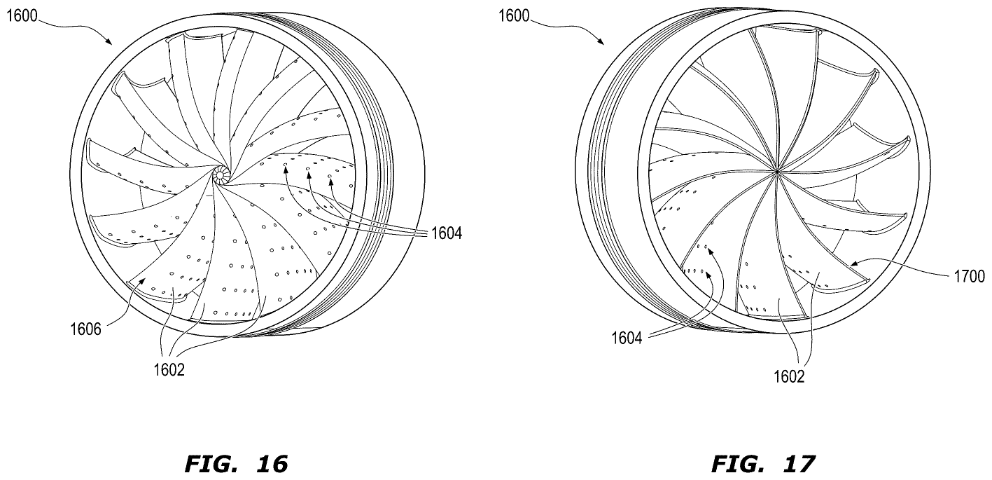

In some examples, a mixer device can include airfoils without any airfoil surface perturbations (e.g., no wavelets, no serrations, etc.). In accordance with one or more such examples, FIGS. 16-20 respectively illustrate front perspective, rear perspective, side perspective, and various cross-sectional views of a mixer device 1600. As shown, the mixer device 1600 can include airfoils 1602 with perforations 1604, similar to the airfoils 306 and corresponding perforations 310. Between a leading edge 1606 and a trailing edge 1700, however, the major surfaces of the airfoils 1602 are devoid of any airfoil surface perturbation.

In these or other examples, fluid mixing can occur due to fluid engagement with the airfoils 1602. For example, oncoming fluid can contact and split at the leading edge 1606 of the airfoils 1602 and cross over the airfoils 1602 to intersect inoculant dispersed from the perforations 1604. The differing fluid velocities between the underside and topside of the airfoil surfaces can also induce desired mixing of fluids.

As shown in FIG. 18, the mixer device 1600 can include seal channels 1800, which can be the same as or similar to the seal channels 700 discussed above. A second fluid (e.g., an inoculant) can be pressurized and pumped into an injection cavity 1802, which is fluidly sealed off from the ambient environment via seal components or gaskets positioned within the seal channels 1800 to control volume output of the inoculant and help mitigate backflow of the first fluid into the airfoil perforations (as discussed above). In the mixer device 1600, the injection cavity 1802 positionally coincides with fluid inlets 1804 defined in the housing surface.

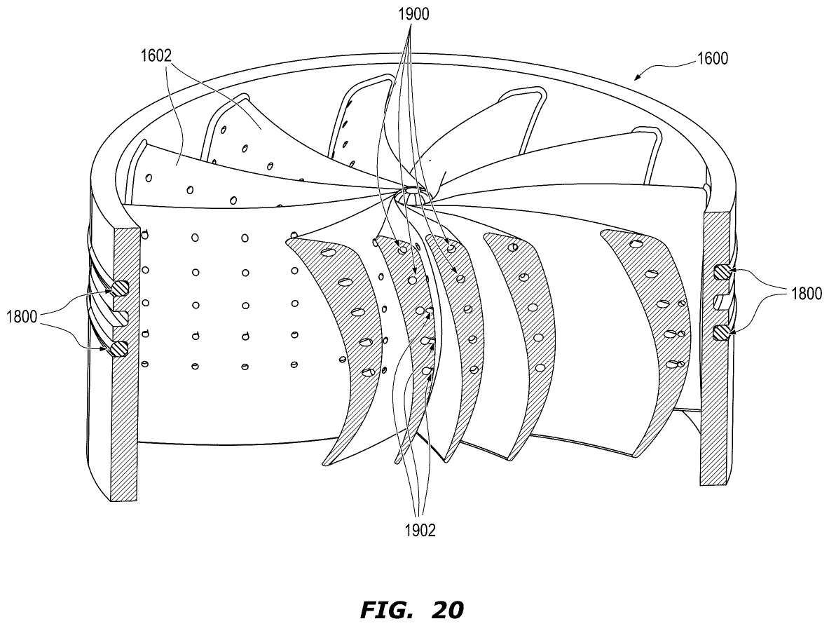

As shown in FIGS. 19-20, the fluid inlets 1804 are in fluid communication with the perforations 1604. In particular, the fluid inlets 1804 lead into airfoil channels 1900 (e.g., arteries, passageways, or fluid tunnels) that extend through the interior of the airfoils 1602. The airfoil channels 1900 then fluidly connect to capillaries 1902 for dispersing fluid through the perforations 1604.

Any of the features, components, and/or parts, including the arrangements and configurations thereof shown in FIGS. 16-20 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 16-20.

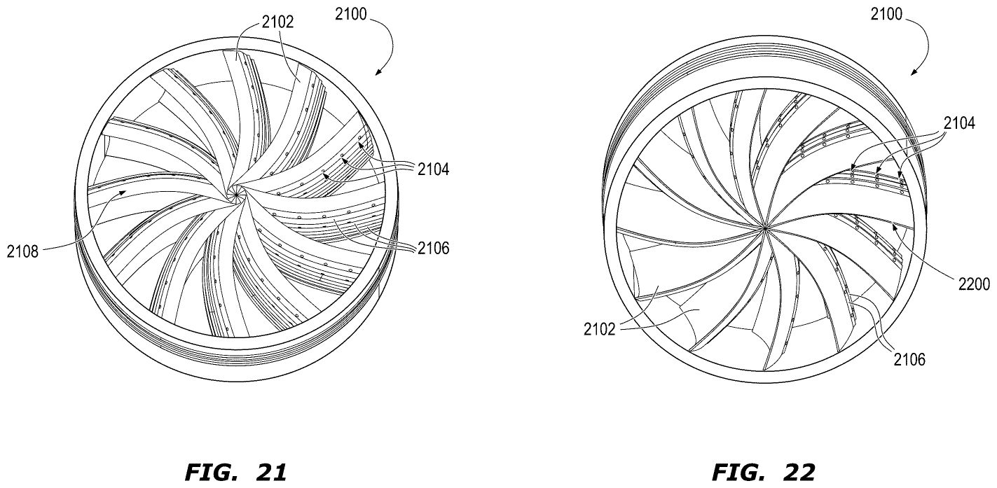

In some examples, a mixer device can include airfoils with wavelets, but without serrations. In accordance with one or more such examples, FIGS. 21-22 respectively illustrate front perspective and rear perspective views of a mixer device 2100. As shown, the mixer device 2100 can include airfoils 2102 having perforations 2104 and wavelets 2106 between a leading edge 2108 and a trailing edge 2200, similar to one or more examples previously described above. In these or other examples, a mixing event can occur as fluid is dispersed through the perforations 2104 and as oncoming fluid proceeds across the wavelets 2106, as similarly described above for the first mixing event in conjunction with FIG. 12.

Any of the features, components, and/or parts, including the arrangements and configurations thereof shown in FIGS. 21-22 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 21-22.

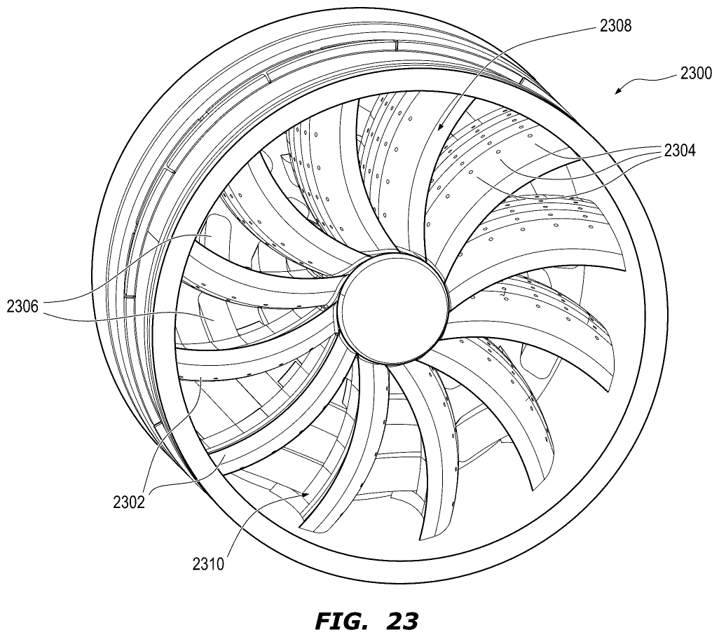

In some examples, a mixer device can include airfoils with serrations, but without wavelets. In accordance with one or more such examples, FIG. 23 illustrates an example mixer device 2300. As shown, the mixer device 2300 can include airfoils 2302 having perforations 2304 along the top major surface and serrations 2306 at a trailing edge 2310 opposite a leading edge 2308, similar to one or more examples previously described above. In these or other examples, a mixing event can occur as fluid engages the serration members, as similarly described above for the second mixing event in conjunction with FIG. 12.

Any of the features, components, and/or parts, including the arrangements and configurations thereof shown in FIG. 23 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 23.

As mentioned above, a housing of a mixer device can include a wide variety of shapes and sizes (e.g., based on fluid conditions, processing or mixing requirements, installation constraints, etc.). In some examples, a mixer device housing is non-circular. In these or other examples, the mixer device housing can be applied in non-pipe settings (e.g., open environment settings, a rectangular shaped channel, a box-shaped conduit, spillways, laboratory apparatuses, etc.). In accordance with one or more such examples, FIGS. 24-26 respectively illustrate front perspective, rear perspective, and cross-sectional views of a mixer device 2400.

As shown, the mixer device 2400 can include a housing 2402 having a rectangular shape that defines a main opening 2403 and an exit opening 2500. In addition, the mixer device 2400 can include airfoils 2404 having a lenticular shape with a leading edge 2410 and a trailing edge 2504. Both ends of the airfoils 2404 can be affixed to the housing 2402. The airfoils 2404 can also include airfoil surface perturbations 2406, 2502 (similar to the airfoil surface perturbations 308 and the airfoil surface perturbations 402 discussed above). Additionally, the airfoils 2404 can define perforations 2408 in one or more major surfaces of the airfoils 2404.

In particular examples, a second fluid can be dispersed through the perforations 2408 as oncoming fluid passes across the airfoils 2404. In these or other examples, the second fluid can be injected into the fluid inlet 2412, which is fluidly connected to an injection cavity 2602 enclosed by the housing 2402. By enclosing the injection cavity 2602, the mixer device 2400 can be implemented in a wide variety of environments without any need for the housing 2402 to sealingly engage a sidewall, a pipe wall, etc.

In some examples, injected fluid can pass from the injection cavity 2602 and into cavity inlets 2604 that fluidly connect to airfoil cavities 2600 defined by interior portions of each of the airfoils 2404. In this manner, injected (and pressurized) fluid can then exit the airfoil cavities 2600 and pass through the perforations 2408 to mix in with oncoming fluid passing over the airfoils 2404, as similarly described above.

Any of the features, components, and/or parts, including the arrangements and configurations thereof shown in FIGS. 24-26 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 24-26.

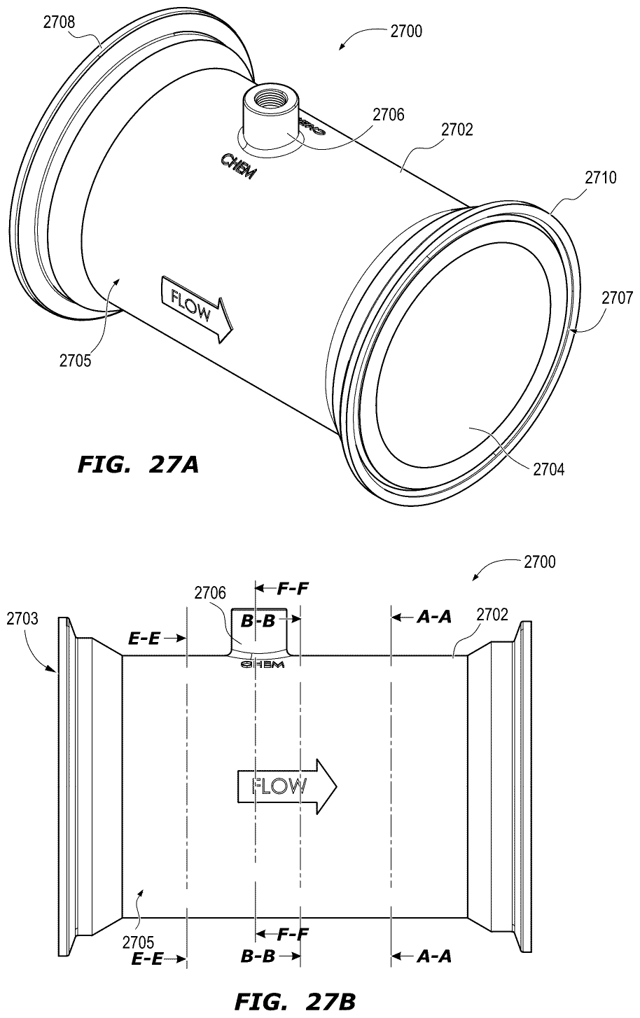

As mentioned above, one or more embodiments of a disclosed mixer apparatus housing can include a unified housing. FIGS. 27A-27B respectively illustrate an isometric view and a side view of a fluid mixer apparatus 2700 implementing such a unified housing in accordance with one or more examples of the present disclosure. As illustrated, the fluid mixer apparatus 2700 can include a single-piece housing 2702, otherwise known as a unified housing, that can define a fluid flow path 2704 (e.g., defined by the interior sidewalls of the single-piece housing 2702 and directionally parallel to the longitudinal axis of the single-piece housing 2702). The fluid flow path 2704 can extend front to back through the fluid mixer apparatus 2700 from a main inlet (for a first fluid) to a main outlet (for a mixture of first and second fluids). In particular, the fluid flow path 2704 can enable (e.g., direct, contain, funnel, or otherwise bound the flow of) a first fluid to flow into the single-piece housing 2702 in a flow direction from front to rear indicated in the “flow” arrow depicted in FIG. 27A. Along the fluid flow path 2704, a second fluid can be introduced into and mixed with the first fluid.

In more detail, the first fluid (which can include one or more fluids referred to in combination as a “first fluid”) can enter through a first opening 2703 of the single-piece housing 2702. The fluid mixer apparatus 2700 can also include a fluid inlet 2706 that is defined on an exterior surface 2705 of the single-piece housing 2702. The fluid inlet 2706 can receive a second fluid different from the first fluid. As described above, the second fluid can include an inoculant or one or more of acids, asphalten removers, cleaners and degreasers, CO₂ scavengers, corrosion inhibitors, defoamers, dispersants, emulsion breakers, foaming agents, H₂S scavengers, microbicides, oxygen scavengers, paraffin (wax) inhibitors, paraffin solvents, salt inhibitors, scale inhibitors, scale removers, sulfur removers, surfactants, water purifying agents, water clarifiers, etc.

The single-piece housing 2702 can include a variety of structural elements and configurations that facilitate a desired connection to one or more fluid applications (e.g., pipes, pipe ends, hoses, etc.). In one or more examples, the single-piece housing 2702 can define a first flange 2708 and a second flange 2710. A flange, such as the first flange 2708 and the second flange 2710, can be a flat, disc-shaped rim that can connect to pipes, valves, plumbing equipment, or the like. In some examples, the flanges 2708, and 2710 of the single-piece housing 2702 can be secured to pipes and/or other connectors, for example, via fastener connections, one or more gaskets, clamp/compression forces, etc. In some examples, flanges can be weld-neck, slip-on, blind, or the like. The flanges 2708, 2710 of the single-piece housing 2702 can be designed such that any type of mating flange or coupling can secure to the single-piece housing 2702. In certain implementations, the flanges 2708, 2710 can be sized and shaped for specific types of industry connections. In this way, the single-piece housing 2702 can be universally adaptable and can be introduced into a pre-existing system, for example a plumbing system, without modifications to the pre-existing system.

As illustrated in FIG. 27A, the flanges 2708, 2710 of the single-piece housing 2702 can define a channel 2707. In some examples, the channel 2707 defined in the flanges 2708, 2710 can be defined such that an O-ring can be disposed in the channel 2707. In this way, as the flanges 2708, 2710 can be secured to other pipes in a system, and the O-ring disposed in the channel 2707 can help create a seal (e.g., a fluid-tight seal, waterproof seal, hermetic seal, etc.) to help prevent fluid escape outside the fluid flow path 2704.

In one or more examples, the single-piece housing 2702 can be scalable and customizable. For example, the flanges 2708, 2710 of the single-piece housing 2702 can be manufactured to any diameter of pipe to easily secure to any pre-existing or new system, for example, a plumbing system. Additionally or alternatively, the structure of the single-piece housing 2702 can be sized and shaped to accommodate certain fluid flow parameters or fluid characteristics (e.g., a volume throughput or flow rate, fluid pressure, fluid viscosity, fluid particulate size, etc.)

The single-piece housing 2702 can be manufactured in different ways and with a variety of materials. In some examples, the single-piece housing 2702 can be manufactured by additive manufacturing or casting methods. Additive manufacturing, in some examples, can reduce the number of potential failure points when formed as a single, integrally formed or unified piece. Additive manufacturing (or other methods of manufacturing capable of forming integral, single piece devices) can reduce the number of O-ring interfaces or sealing engagements implemented in the system. In one or more examples, the single-piece housing 2702 can be made from field rated polymers (e.g., Polyvinyl Chloride (PVC), Polyethylene, or the like), printed metal (e.g., carbon steel), etc. Many other materials can also be implemented, including metals, composites, non-conductive materials, thermoplastics, food-grade materials, bio-based materials (e.g., timber, clay, etc.), and/or combinations thereof.

Although the single-piece housing 2702 is shown in a particular shape, those of ordinary skill in the art, having the benefit of this disclosure, will recognize that any other housing disclosed herein (including a lenticular-shaped housing shown in FIGS. 24-26) can include a single-piece housing. Indeed, the present disclosure is not limited to single-piece housings of a particular shape, size, or configuration. A single-piece housing as disclosed herein can be adapted and modified in a myriad of different ways suitable for the application and/or environment.

Any of the features, components, and/or parts, including the arrangements and configurations thereof shown in FIGS. 27A-27B can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 27A-27B.

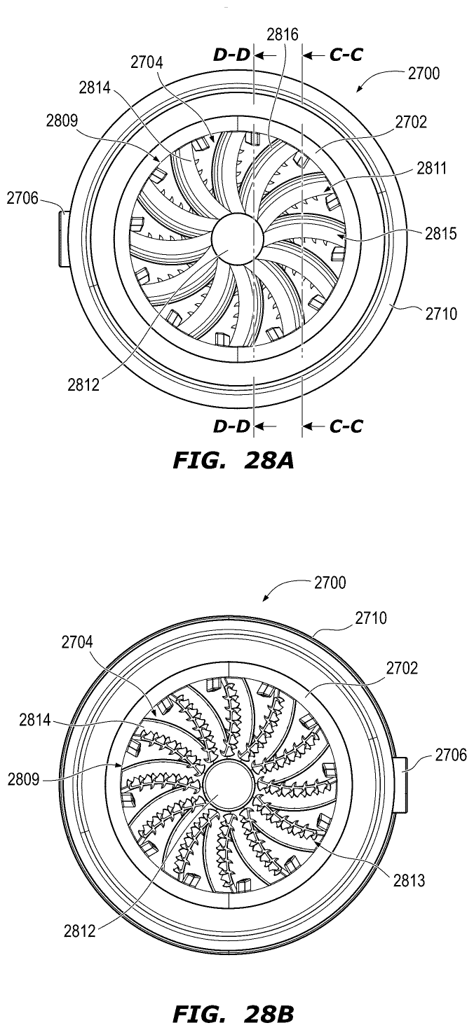

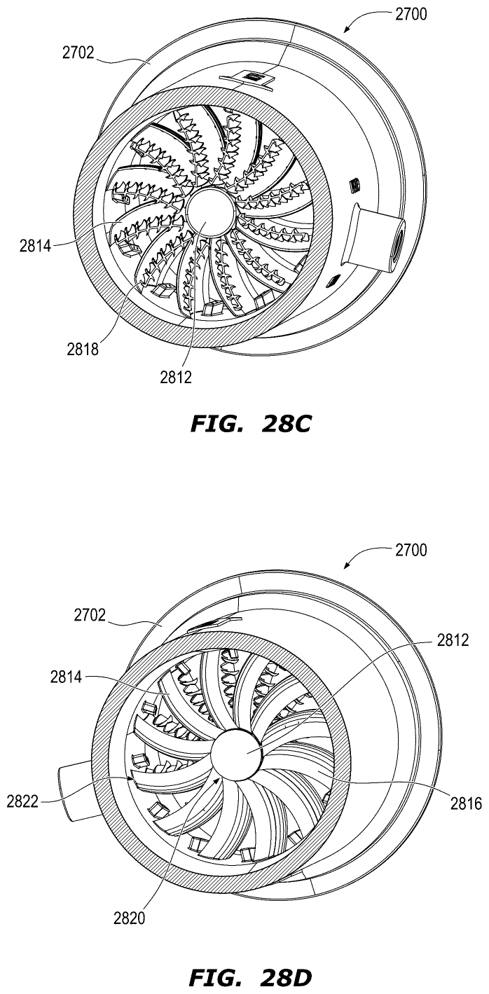

FIGS. 28A-28B respectively illustrate a front view and rear view of the fluid mixer apparatus 2700 in accordance with one or more examples of the present disclosure. As illustrated, the single-piece housing 2702 or unified housing 2702 can define the fluid flow path 2704 configured for a first fluid to flow through the unified housing 2702. In one or more examples, the unified housing 2702 can include a central hub 2812 centrally positioned relative to the fluid flow path 2704. Additionally shown, the unified housing 2702 can further include a plurality of helical airfoils 2814 coupled to the central hub 2812 and extending outward to couple to an interior surface 2809 of the unified housing 2702. That is, the airfoils 2814 in some examples are, unlike a turbine or propeller, immovable relative to the unified housing 2702 (and the central hub 304). The airfoils 2814, in some examples, are thus positionally fixed at both ends. Specifically, an inboard portion 2820 (e.g., the innermost end portions of the airfoils 2814) can be fixed to the central hub 2812, and an outboard portion 2822 (e.g., the outermost end portions of the airfoils 2814) can be fixed to the unified housing 2702.

As illustrated in FIGS. 28A-28B, each helical airfoil of the plurality of helical airfoils 2814 can be positioned in the fluid flow path 2704 and define a leading edge 2811, a trailing edge 2813 (as illustrated in FIG. 28B), a top surface 2815, and a bottom surface opposite the top surface 2815 (one or both of the top and bottom surfaces can be considered a major surface). In more detail, the trailing edge 2813 can be positioned opposite of the leading edge 2811. The leading edge 2811 can split oncoming fluid into a first fluid portion that flows faster across the top surface 2815 of the airfoil and a second fluid portion that flows slower across the bottom surface. The leading edge 2811 of an airfoil 2814 and the trailing edge 2813 of an airfoil 2814 can be contiguous with the major surfaces (e.g., the top and bottom surfaces of the airfoil 2814).

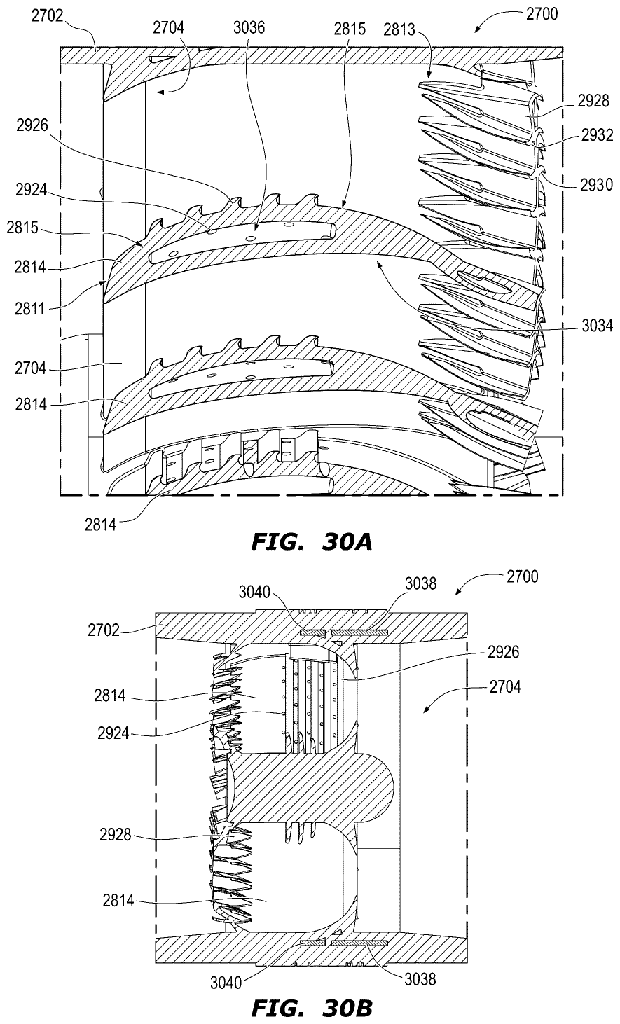

The plurality of airfoils 2814 can include various geometries and features for inducing fluid interactions, as will now be described. FIGS. 28C-28D respectively illustrate a rear isometric cross-sectional view and a front isometric cross-sectional view along corresponding cut lines A-A and E-E of FIG. 27B. In these figures, the plurality of airfoils 2814 can include an airfoil surface perturbation 2816, or as shown, a plurality of airfoil surface perturbations 2816. In one or more examples, the plurality of airfoil surface perturbations 2816 can include wavelets (e.g., ridges, bumps, protrusions, crests, or the like). In some examples, the plurality of airfoil surface perturbations 2816 can include crested wavelets (as will be discussed more in relation to FIG. 30). In one or more examples, the plurality of airfoil surface perturbations 2816 can extend from an inboard portion 2820 of the helical airfoil 2814 to an outboard portion 2822 of the helical airfoil 2814, or in some examples, only partially between the inboard portion 2820 and the outboard portion 2822. The airfoil surface perturbations 2816 can include a series of wavelet rows aligned one after another (or rearward) of the other, according to some examples. As illustrated in FIG. 28, the series of wavelet rows can span between the leading edge 2811 and the trailing edge 2813, or in some examples, only span a section of the airfoil surface between the leading edge 2811 and the trailing edge 2813. Indeed, the series of wavelet rows can extend any distance from the leading edge 2811 to the trailing edge 2813 on the top surface 2815. In alternative examples, the airfoil surface perturbations 2816 can include offset or staggered rows such that there is only partial overlap between subsequent wavelet rows.

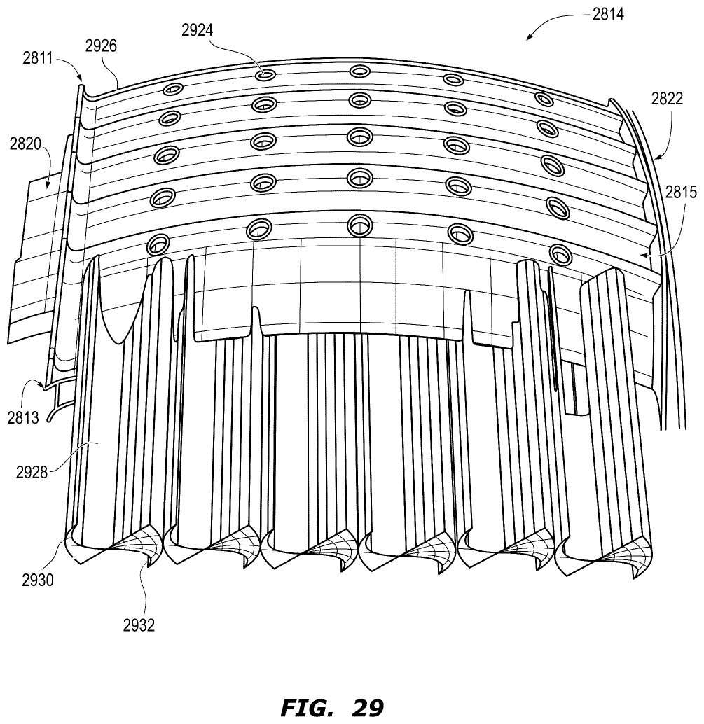

In some examples, the trailing edge 2813 can include airfoil surface perturbations 2818. In one or more examples, the airfoil surface perturbations 2818 can comprise a plurality of serrations with various geometrical configurations and arrangements (e.g., helical serrations, double crest serrations, top and bottom serrations, mirrored serrations, etc.) along the trailing edge 2813 of the helical airfoil 2814. In specific examples, the plurality of serrations can include one or more rows of helical serrations. In more detail, each helical serration of the row of helical serrations can include a first helical portion protruding upward from the trailing edge 2813 and a second helical portion protruding downward from the trailing edge 2813 (as will be discussed in relation to FIG. 29). As illustrated in FIG. 28C, each helical serration of the row of helical serrations can extend rearward from the trailing edge 2813 of the helical airfoil 2814 (as will be discussed in relation to FIG. 29).

Additionally or alternatively, the helical serrations of the airfoil surface perturbations 2818 can interact with or induce certain fluid mixing behavior. In more detail, the plurality of airfoil surface perturbations 2816 (e.g., crested wavelets) can induce a first mixing event before the trailing edge 2813, and the plurality of serrations (e.g., helical serrations) of the airfoil surface perturbations 2818 can induce a second mixing event after the trailing edge 2813 (as will be discussed in relation to FIG. 30A). In some examples, the second mixing event induced by the helical serrations of the airfoil surface perturbations 2818 can compound, add to, or otherwise influence the fluid flow characteristics imparted by the first mixing event with the airfoil surface perturbations 2816 positioned forward of the airfoil surface perturbations 2818.

Any of the features, components, and/or parts, including the arrangements and configurations thereof shown in FIGS. 28A-28D can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 28A-28D.

FIG. 29 illustrates a perspective view of a helical airfoil 2814 in accordance with one or more examples of the present disclosure. In one or more examples, the helical airfoil 2814 can include a leading edge 2811, a trailing edge 2813 positioned opposite of the leading edge 2811, a top surface 2815, and a bottom surface (not illustrated). The helical airfoil 2814 can further include a plurality of perforations 2924 defined at least by the top surface 2815 (and in some cases, the bottom surface or both surfaces). As illustrated in FIG. 29, the plurality of perforations 2924 can extend (e.g., in rows) between the inboard portion 2820 of the helical airfoil 2814 to the outboard portion 2822 of the helical airfoil 2814. The plurality of perforations 2924 can be positioned adjacent to one or more airfoil surface perturbations (e.g., crested wavelets 2926). For example, the plurality of perforations 2924 can be positioned in the valleys or troughs (e.g., low-lying areas) in between adjacent crested wavelets 2926. In certain examples, the plurality of perforations 2924 can be positioned on the structure of the crested wavelets themselves (e.g., on the forward side of the crested wavelet leading into the crest and prior to the wavelet curling back into itself, or on the rearward side of the crested wavelet after the wave crest). In these or other examples, the plurality of perforations 2924 can be positioned so as to introduce a second fluid into the first fluid at a location that can enhance, improve, or optimize fluid mixing in relation to the plurality of crested wavelets 2926.

As just discussed, FIG. helical airfoil 2814 can further include a plurality of crested wavelets 2926. Like the plurality of perforations 2924, the plurality of crested wavelets 2926 can extend (entirely or partially) from the inboard portion 2820 of the helical airfoil 2814 to the outboard portion 2822 of the helical airfoil 2814. IG. Each crested wavelet of the plurality of crested wavelets 2926 can, in some examples, include a distinct wave crest (e.g., a top portion or upper edge). In certain examples, the plurality of crested wavelets 2926 can include a circular orbit (typical of symmetrical waves), an elliptical orbit (typical of a breaking wave), or a combination of different wave geometries. With an elliptical orbit, the wavelet can be defined by a rounded portion on the forward side of the wave crest, a flattened top near the crest, and a curl-back bend section on the rearward side. Many other wavelet configurations, however, are herein contemplated.

As illustrated in FIG. 29, the trailing edge 2813 can include a plurality of serrations, particularly a row of helical serrations 2928. As illustrated, the row of helical serrations 2928 can include a plurality of helical serrations extending from the inboard portion 2820 of the helical airfoil 2814 to the outboard portion 2822 of the helical airfoil 2814 (or partially therebetween). In one or more examples, each helical serration of the row of helical serrations 2928 can include a first helical portion 2930 that can protrude upward from the trailing edge 2813 and a second helical portion 2932 that can protrude downward from the trailing edge 2813. In certain examples, each helical serration of the row of helical serrations 2928 can be modeled in a geometrically similar manner to an Archimedean screw, a hydrodynamic screw, a water screw, or an Egyptian screw. As illustrated in FIG. 29, each helical serration of the row of helical serrations 2928 can extend rearward from the trailing edge 2813 of the helical airfoil 2814. The row of helical serrations 2928 can extend rearward from the trailing edge 2813 for a predetermined length (e.g., about 1 inch to about 12 inches) according to a desired fluid interaction and fluid flow characteristics.

In one or more examples, the plurality of crested wavelets 2926 is configured to induce fluid recursion leading into the plurality of helical serrations 2928. As discussed above, fluid recursion can include fluid eddies that rise upward and roll backward onto themselves about rotational axes. In more detail, the fluid eddies can mix together a first fluid and a second fluid (discussed in more detail below).

In one or more examples, each helical serration of the plurality of helical serrations 2928 can twist in a helical formation as the plurality of helical serrations 2928 extend rearward (e.g., longitudinally away) from the trailing edge 2813. For example, the height of a helical serration (i.e., the distance of protrusion relative to the airfoil surface) can vary as the helical serration extends rearward. In these or other examples, the amount or rate of twist for each helical serration can be the same or different. For example, each helical serration of the plurality of helical serrations 2928 can twist at a different rate depending on the position of the helical serration along the trailing edge 2813 (either closer or farther away from the inboard portion or outboard portion). In some examples, a predetermined rate of twist can introduce desired vortices of the fluid to increase mixing, for example of a first fluid and a second fluid, at specific locations along the trailing edge 2813.

Any of the features, components, and/or parts, including the arrangements and configurations thereof shown in FIG. 29 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 29.

FIG. 30A illustrates a cross-sectional perspective view along cut line C-C of FIG. 28A of the fluid mixer apparatus 2700 in accordance with one or more examples of the present disclosure. The fluid mixer apparatus 2700 can include a plurality of helical airfoils 2814. The helical airfoils 2814 can define the top surface 2815 and a bottom surface 3034 opposite the top surface 2815. As illustrated in FIG. 30, the plurality of helical airfoils 2814 can include a plurality of perforations 2924. Furthermore, as illustrated, the plurality of helical airfoils 2814 can include airfoil surface perturbations defined as crested wavelets 2926 such that the airfoil surface perturbations are positioned adjacent to or rearward of the plurality of perforations 2924. As illustrated in FIG. 30, the crested wavelets 2926 can crest over at least a portion of the plurality of perforation 2924. In this way, the crested wavelets can induce a fluid recursion, for example between a fluid traveling over the crest of the crested wavelet 2926 and a fluid traveling out of the plurality of perforations 2924 (as will be discussed in regard to FIG. 30B). In one or more examples, each airfoil of the plurality of helical airfoils 2814 can define a cavity 3036 (e.g., an interior reservoir, hollow portion, or open space) that can receive the second fluid discussed above for introducing into the main fluid flow of the first fluid. The plurality of perforations 2924 can be in fluid communication with the cavity 3036 defined by each of the plurality of helical airfoils 2814. As discussed below, a second fluid positioned inside the cavity 3036 can be pushed out of the helical airfoil 2814 through the plurality of perforations 2924.

FIG. 30B illustrates a cross-sectional view along cutline D-D of FIG. 28A of the fluid mixer apparatus 2700 in accordance with one or more examples of the present disclosure. The fluid mixer apparatus 2700 can include the unified housing 2702 discussed above. In one or more examples, the fluid mixer apparatus 2700 can include a first inner chamber 3038 defined inside the unified housing 2702. In some examples, the first inner chamber 3038 can extend circumferentially around the entirety of the unified housing 2702. The first inner chamber 3038 can receive a second fluid from the fluid inlet (not illustrated), such as the fluid inlet 2706 illustrated in FIG. 27A. In more detail, the second fluid, for example can include an inoculant or the like, to be introduced to a first fluid flowing through the unified housing 2702 along the fluid flow path 2704. In one or more examples, the first inner chamber 3038 can be configured to stabilize the pressure and flow of the second fluid received by the fluid inlet. For example, the first inner chamber 3038 can absorb pressure fluctuation of the incoming second fluid and distribute the pressure and fluid flow evenly throughout the first inner chamber 3038.

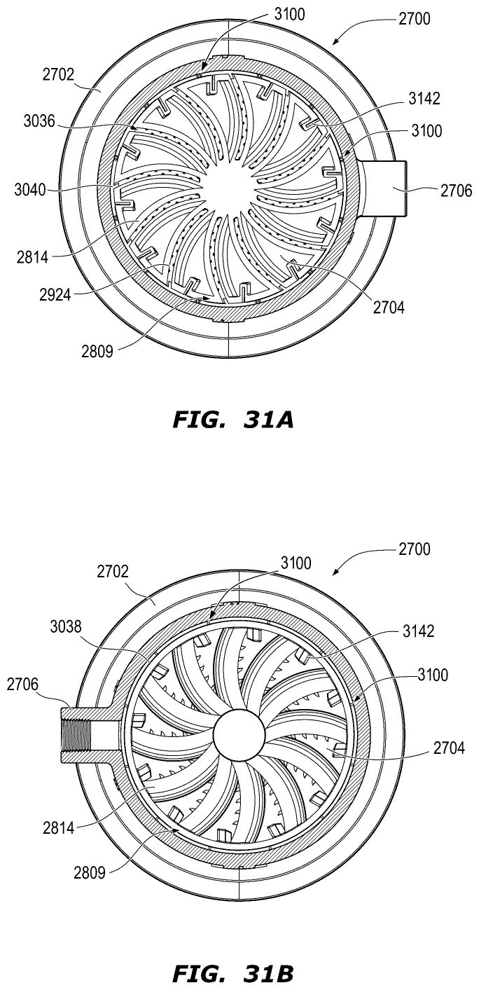

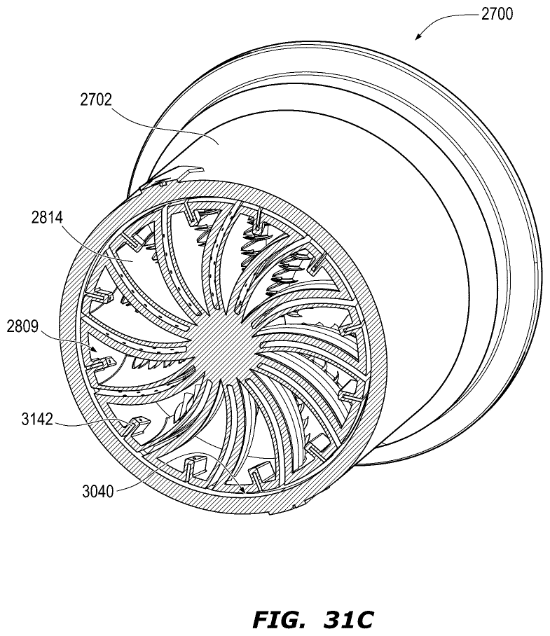

The fluid mixer apparatus 2700 can further include a second inner chamber 3040 defined inside the unified housing 2702 adjacent to the first inner chamber 3038. The second inner chamber 3040 can receive the stabilized flow of the second fluid from the first inner chamber 3038. In one or more examples, the fluid mixer apparatus 2700 can further include a plurality of discrete connection ports (e.g., connection ports 3100 shown in FIGS. 31A-31B) fluidly connecting the first inner chamber 3038 and the second inner chamber 3040. In this example, the first inner chamber 3038 can be fluidly connected to the second inner chamber 3040 via the plurality of discrete connection ports 3100. In an alternate example, the fluid mixer apparatus 2700 can include a single inner chamber defined inside the unified housing 2702. In this example, the single inner chamber can receive the second fluid from the fluid inlet for subsequent distribution into the helical airfoils.

In one or more examples, the cavity 3036 defined in each helical airfoil of the plurality of airfoils 2814 can be in fluid communication with the second inner chamber 3040 (e.g., via the connection ports 3100). In turn, the plurality of perforations 2924 can be in fluid communication with the second inner chamber 3040 via the cavity 3036. In one or more examples, as the first fluid flows through the fluid flow path 2704, the second fluid can be provided via the fluid inlet 2706 to the first inner chamber 3038, where the second fluid can be stabilized and/or even distributed throughout the interior of the single-piece housing 2702. The second fluid can then flow evenly into the second inner chamber 3040. The second fluid can then flow from the second inner chamber 3040 to the cavity 3036 of the helical airfoil 2814, wherein the second fluid can flow from the cavity 3036 out of the plurality of perforations 2924 to mix with a first fluid.

In these or other examples, as the first fluid flows over the crested wavelet 2926, the first fluid can form a vortex shedding condition (e.g., a vortex-generating fluid environment) causing the second fluid to be drawn out of the plurality of perforations 2924 to interact with the first fluid. In this way, the interaction of the first fluid and the second fluid can induce the von-Karman effect. The von-Karman effect can refer to a fluid behavior that occurs when a fluid flows past an object or shape (e.g., a blunted object such as the crested wavelet 2926). Under the von-Karman effect, the fluid flow can separate at the edge of the wave crest, thereby creating an alternating low-pressure area that forms swirling vortices. In some examples, the von-Karman effect induced by the crested wavelets 2926 can induce the mixing of the first fluid and the second fluid (e.g., a first mixing event discussed in more detail below).

As illustrated in FIG. 30A, the fluid mixer apparatus 2700 can further include a plurality of helical serrations 2928 extending from the trailing edge 2813 of the helical airfoils 2814. As discussed above, each helical serrations of the plurality of helical serrations 2928 can define a first helical portion 2930 extending upward from the trailing edge 2813, and a second helical portion 2932 extending downward from the trailing edge 2813. As discussed above, as a first fluid enters the fluid flow path 2704 of the unified housing 2702 the fluid can be split by the leading edge 2811 with at least a portion of the fluid flowing over the top surface 2815. In this example, the fluid flowing over the top surface interacts with the plurality of crested wavelets 2926 that induce a first mixing event before the trailing edge 2813. In this way, the first mixing event (e.g., the von-Karman effect) can mix the first fluid flowing over the crested wavelets 2926 with the second fluid being introduced by the plurality of perforations 2924 under the crested wavelets 2926 at the wave troughs.

As discussed above, the crested wavelets 2926 can induce interacting vortices to mix the first and second fluid. In this example, as the first fluid and second fluid intermix via the first mixing event, the plurality of helical serrations 2928 can induce a second mixing event after the trailing edge 2813. In more detail, the plurality of helical serrations 2928 can induce interacting vortices (e.g., the second mixing event) to increase or enhance the interaction between the first and second fluids to uniformly mix the first and second fluid together. In some examples, the twisting geometry of the helical serrations 2928 can wrap or direct the fluid in a manner that causes the fluid to similarly spiral and form vortices that have central axes parallel to the fluid flow through the single-piece housing 2702 (but perpendicular to the central axes of the vortices emerging from the first mixing event off the crested wavelets 2926). This relationship of axes for the respective vortices is similarly described above in relation to FIG. 12. In certain implementations, however, the twist of the helical serrations 2928 can induce a more controlled amplitude, stronger fluid interactions, etc. In at least one example, the twisting geometry of the helical serrations 2928 can better prevent fluid clogging and/or eliminate dead zones with poor mixing.

Any of the features, components, and/or parts, including the arrangements and configurations thereof shown in FIGS. 30A-30B can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in 30A-30B.

FIGS. 31A-31C respectively illustrate a rear cross-sectional view along cut line B-B, a front cross-sectional view along cut line F-F, and a front perspective cross-sectional view along cut line B-B of FIG. 27B. In one example, the fluid mixer apparatus 2700 can include a fluid inlet 2706 configured to receive a second fluid. As illustrated in FIG. 31B, the fluid inlet 2706 can transfer the received second fluid to a first inner chamber 3038 extending around the unified housing 2702. As discussed above, the first inner chamber 3038 can stabilize the pressure and fluid of the second fluid from the fluid inlet 2706. The stabilized second fluid can be transferred from the first inner chamber 3038 to the second inner chamber 3040 via discrete connection ports 3100.

As illustrated in FIG. 31A, the second inner chamber 3040 can extend around the periphery of the unified housing 2702. The second inner chamber 3040 is in fluid communication with each cavity 3036 of each helical airfoil of the plurality of airfoils 2814. As illustrated in FIGS. 31A and 31C, the cavity 3036 can extend the length of the helical airfoil 2814 and fluidly couple to the plurality of perforations 2924. In this way, the cavity 3036 and plurality of perforations 2924 extending the length of the helical airfoil 2814 can uniformly release a second fluid out from the helical airfoil 2814 into the fluid flow path 2704 as the first fluid flows through the uniform housing 2702. In one or more examples, the plurality of perforations 2924 can be arranged in a variety of different ways depending on fluid properties, flow rate, volume throughput, desired mixing levels, or the like.

In one or more examples, the fluid mixer apparatus 2700 can include a plurality of flow modifiers 3142 (e.g., mini-airfoils, mixing wedges, blocks, walls, protrusions, ribs, etc. that can introduce additional inoculant/fluid and/or further induce mixing, break apart fluid clumps, and/or direct fluid flow). As illustrated in FIGS. 31A-31C, the plurality of flow modifiers 3142 can be coupled about the interior surface 2809 of the unified housing 2702. As illustrated, the plurality of flow modifiers 3142 can be respectively positioned between a pair of helical airfoils of the plurality of airfoils 2814. The plurality of flow modifiers 3142 can be arranged between each helical airfoil of the plurality of helical airfoils 2814. In some examples, however, the plurality of flow modifiers 3142 are positioned between some of the helical airfoils 2814 (e.g., between every other helical airfoil 2814, or every third helical airfoil 2814, or any other suitable combination). In at least some examples, the plurality of flow modifiers 3142 are positioned at a location of greatest spread or distance between adjacent airfoil surfaces (e.g., where mixing and/or second fluid introduction may otherwise be comparatively reduced in relation to locations where the airfoils are closer together). The plurality of flow modifiers 3142 can be arranged in many other different ways depending on the applied application, properties of fluid, desired mixing level, or the like.

In one or more examples, each wedge of the plurality of flow modifiers 3142 can define a cavity in fluid communication with the second inner chamber 3040. In this example, each wedge of the plurality of flow modifiers 3142 can further include a perforation (or multiple perforations) in fluid communication with the cavity. In this way, each wedge of the plurality of flow modifiers 3142 can introduce a second fluid from the second inner chamber 3040 into the first fluid. As illustrated in FIG. 31A, the second inner chamber 3040 can uniformly distribute the second fluid to both of the plurality of helical airfoils 2814 and the plurality of flow modifiers 3142.

The plurality of flow modifiers 3142 can be sized and shaped according to many different configurations. In some examples, the plurality of flow modifiers 3142 are shaped like miniature airfoils. Other examples are also contemplated. For instance, and as illustrated in FIGS. 31B and 31C (also in reference to FIG. 28C), the plurality of modifiers 3142 can be formed as a rhombus shape configured with a pointed leading edge and trailing edge. In this way, the leading edge of the plurality of flow modifiers 3142 can split the incoming first fluid and induce mixing vortices to induce mixing between the first fluid and the second fluid. Additionally or alternatively, the plurality of flow modifiers 3142 can serve as an additional point of contact to emulsify, break up, loosen, or pulverize particulate chunks in the first fluid. In at least one example including multiple perforations, a radial height of the plurality of flow modifiers can vary from the leading edge to the trailing edge (e.g., so that a second fluid is drawn more easily out of the multiple perforations). In one or more examples, the shape of the plurality of flow modifiers 3142 can be varied based on the fluid properties, flow rate, volume throughput, desired mixing levels, and the like.

Any of the features, components, and/or parts, including the arrangements and configurations thereof shown in FIGS. 31A-31B can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in 31A-31B. For example, the fluid mixer apparatus 2700 as shown and described can be modified to include seals, gaskets, etc. (similar to or the same as those of the mixer device 300) so that the mixer device structure can be removably attached, sealed, and integrated with the single-piece housing 2702 (and subsequently detached therefrom as desired).

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art that many modifications and variations are possible in view of the above teachings. Indeed, various inventions have been described herein with reference to certain specific aspects and examples. However, they will be recognized by those skilled in the art that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.” Additionally, the terms “about,” “approximately,” and “substantially” should be interpreted as +/−10 percent of a stated value.

What is claimed is:

1. A fluid mixer apparatus, comprising:
a single-piece housing defining a fluid flow path configured for a first fluid through the single-piece housing;
a fluid inlet defined on an exterior surface of the single-piece housing, the fluid inlet configured to receive a second fluid different from the first fluid;
an inner chamber circumferentially defined inside the single-piece housing, the inner chamber configured to receive the second fluid from the fluid inlet;
a central hub; and
a plurality of helical airfoils coupled to an interior surface of the single-piece housing and the central hub, the plurality of helical airfoils being in fluid communication with the inner chamber, each helical airfoil of the plurality of helical airfoils comprising:
a plurality of perforations in fluid communication with the inner chamber to introduce the second fluid into the first fluid; and
an airfoil surface perturbation positioned adjacent to or rearward of the plurality of perforations.

2. The fluid mixer apparatus of claim 1, wherein the airfoil surface perturbation comprises a wavelet or a crested wavelet.

3. The fluid mixer apparatus of claim 1, wherein the airfoil surface perturbation extends from an inboard portion of the helical airfoil to an outboard portion of the helical airfoil.

4. The fluid mixer apparatus of claim 1, wherein the plurality of perforations extends along a length of the airfoil surface perturbation.

5. The fluid mixer apparatus of claim 1, wherein when the first fluid flows over the airfoil surface perturbation, the first fluid forms an eddie and the second fluid is drawn out from the plurality of perforations to interact with the first fluid.

6. The fluid mixer apparatus of claim 5, wherein interaction of the first fluid and the second fluid are configured to induce von-Karman effects or wave vortices.

7. The fluid mixer apparatus of claim 1, wherein the airfoil surface perturbation comprises a plurality of serrations along a trailing edge of the helical airfoil.

8. The fluid mixer apparatus of claim 7, wherein:
the plurality of serrations comprises a row of helical serrations; and
each helical serration of the row of helical serrations comprises a first helical portion protruding upward from the trailing edge and a second helical portion protruding downward from the trailing edge.

9. The fluid mixer apparatus of claim 8, wherein each helical serration of the row of helical serrations extends rearward from the trailing edge of the helical airfoil.

10. The fluid mixer apparatus of claim 1, wherein the central hub and the plurality of helical airfoils are integrally formed together as a single unit.

11. A mixing device connectable to an open end of a pipe, comprising:
a unified housing defining a fluid flow path configured for a first fluid to move through the unified housing;
a fluid inlet disposed on an exterior surface of the unified housing, the first fluid inlet configured to receive a second fluid different than the first fluid;
a first inner chamber defined inside the unified housing, the first inner chamber configured to receive the second fluid from the fluid inlet;
a second inner chamber defined inside the unified housing adjacent to the first inner chamber, the second inner chamber in fluid communication with the first inner chamber;
a plurality of airfoils coupled to the unified housing and positioned in the fluid flow path, each airfoil of the plurality of airfoils comprising:
a leading edge;
a trailing edge positioned opposite of the leading edge;
a top surface and a bottom surface opposite the top surface;
a plurality of perforations defined at least by the top surface, the plurality of perforations in fluid communication with the second inner chamber; and
a plurality of crested wavelets positioned adjacent to the plurality of perforations.

12. The mixing device of claim 11, wherein the plurality of crested wavelets is positioned adjacent to the plurality of perforations to induce a first mixing event before the trailing edge.

13. The mixing device of claim 11, wherein each airfoil of the plurality of airfoils comprises an airfoil surface perturbation positioned along the trailing edge.

14. The mixing device of claim 13, wherein the airfoil surface perturbation positioned along the trailing edge is configured to induce a second mixing event after the trailing edge.

15. The mixing device of claim 11, wherein the first inner chamber is configured to stabilize the pressure and flow of the second fluid received from the fluid inlet.

16. The mixing device of claim 11, further comprising a plurality of discrete connection ports fluidly connecting the first inner chamber and the second inner chamber.

17. The mixing device of claim 16, wherein each airfoil of the plurality of airfoils comprises an interior portion defining a cavity in fluid communication with the second inner chamber and the plurality of perforations.

18. A mixing device, comprising:
a housing, the housing defining:
a fluid intake;
a first chamber in fluid communication with the fluid intake; and
a second chamber in fluid communication with the first chamber;
a plurality of airfoils affixed to the housing, each airfoil of the plurality of airfoils comprising:
a leading edge;
a trailing edge positioned opposite of the leading edge and comprising a plurality of helical serrations; and
a major surface extending between the leading edge and the trailing edge, the major surface defining:
a plurality of perforations in fluid communications with the second chamber; and
a plurality of crested wavelets positioned on the major surface and adjacent to the plurality of perforations.

19. The mixing device of claim 18, wherein the plurality of crested wavelets is configured to induce fluid recursion leading into the plurality of helical serrations.

20. The mixing device of claim 18, further comprising a plurality of flow modifiers coupled to the housing and extending radially inward, each flow modifier of the plurality of flow modifiers being respectively positioned between a pair of airfoils of the plurality of airfoils, and each flow modifier of the plurality of flow modifiers defining a perforation in fluid communication with the second chamber.
